(19) United States
(12) Patent Application Publication
(10) Pub. No.: US 2026/0362483 A1
(43) Pub. Date: Nov. 12, 2026

(54) METHOD AND DEVICE FOR COUNTING NUMBER OF LISTEN BEFORE TALK (LBT) FAILURES

(71) Applicant: Beijing Xiaomi Mobile Software Co., Ltd., Beijing (CN)

(72) Inventor: Xiaowei JIANG, Beijing (JP)

(73) Assignee: Beijing Xiaomi Mobile Software Co., Ltd., Beijing (CN)

(21) Appl. No.: 19/125,617

(22) PCT Filed: Nov. 3, 2022
(86) PCT No.: PCT/CN2022/129565

§ 371 Date: Apr. 29, 2025

(51) Int. Cl. H04W 74/0808; H04W 72/40

(52) U.S. Cl. CPC H04W 74/0808; H04W 72/40

(57) ABSTRACT

A method and apparatus for counting Listen-Before-Talk (LBT) failures in sidelink communication, particularly in relation to a Physical Sidelink Feedback Channel (PSFCH) associated with a Hybrid Automatic Repeat Request (HARQ)-enabled Physical Sidelink Shared Channel (PSSCH). A terminal device determines a number of consecutive LBT failures occurring on PSFCH resources and counts such failures based on configurable detection parameters. The method supports multiple granularity levels including resource pools, bandwidth parts (BWPs), and resource block sets, each with independent detection timers and counters. Upon detecting excessive LBT failures, the device may report the condition to a network node or trigger resource reselection or sidelink radio link failure procedures. Configuration information for timers and thresholds may be received from the network.

### CROSS-REFERENCE TO RELATED APPLICATIONS

The present application is a U.S. National Stage of International Application No. PCT/CN 2022/129565, filed on Nov. 3, 2022, the contents of all of which are incorporated herein by reference in their entirety for all purposes.

### BACKGROUND OF THE INVENTION

In the related art, uplink and downlink operations may be performed on an unlicensed frequency band, where accesses to both downlink and uplink channels rely on the characteristic of listen before talk (LBT).

### SUMMARY OF THE INVENTION

The present disclosure relates to the technical field of communication, in particular to a method and device for counting a number of listen before talk (LBT) failures.

A method for counting a number of listen before talk (LBT) failures is provided in an embodiment of a first aspect of the present disclosure, and the method includes:
determining a number of LBT failures that continuously occur on a physical sidelink feedback channel (PSFCH) associated with a hybrid automatic repeat request (HARQ)-enabled physical sidelink shared channel (PSSCH); and
counting a number of LBT failures for the PSFCH according to the number of LBT failures that continuously occur on the PSFCH associated with the HARQ-enabled PSSCH.

Another method for counting the number of LBT failures is provided in an embodiment of a second aspect of the present disclosure, and the method includes:
sending first configuration information to a terminal device, where the first configuration information is configured to determine, by the terminal device, a continuous physical sidelink feedback channel (PSFCH) LBT failure detection timer corresponding to a resource pool, and the continuous PSFCH LBT failure detection timer corresponding to the resource pool is configured to count a number of LBT failures for a PSFCH on the resource pool.

A communication device is provided in an embodiment of a third aspect of the present disclosure, the communication device includes one or more processors and a memory that stores a computer program. The computer program, when collectively executed by the one or more processors, causes the communication device to:
determine a number of LBT failures that continuously occur on a physical sidelink feedback channel (PSFCH) associated with a hybrid automatic repeat request (HARQ)-enabled physical sidelink shared channel (PSSCH); and
count a number of LBT failures for the PSFCH according to the number of LBT failures that continuously occur on the PSFCH associated with the HARQ-enabled PSSCH.

Another communication device is provided in an embodiment of a fourth aspect of the present disclosure, the communication device includes one or more processors and a memory that stores a computer program. The computer program, when collectively executed by the one or more processors, causes the communication device to perform the method described in the second aspect above.

### BRIEF DESCRIPTION OF DRAWINGS

In order to more clearly illustrate technical solutions in embodiments of the present disclosure or the background, accompanying drawings needing to be used in the embodiments of the present disclosure or the background will be illustrated below.

FIG. 1 is a schematic architecture diagram of a communication system provided in an embodiment of the present disclosure.

FIG. 2 is a schematic flowchart of a method for counting a number of listen before talk (LBT) failures provided in an embodiment of the present disclosure.

FIG. 3 is a schematic flowchart of another method for counting the number of LBT failures provided in an embodiment of the present disclosure.

FIG. 4 is a schematic flowchart of another method for counting the number of LBT failures provided in an embodiment of the present disclosure.

FIG. 5 is a schematic flowchart of another method for counting the number of LBT failures provided in an embodiment of the present disclosure.

FIG. 6 is a schematic flowchart of another method for counting the number of LBT failures provided in an embodiment of the present disclosure.

FIG. 7 is a schematic flowchart of another method for counting the number of LBT failures provided in an embodiment of the present disclosure.

FIG. 8 is a schematic flowchart of another method for counting the number of LBT failures provided in an embodiment of the present disclosure.

FIG. 9 is a schematic flowchart of another method for counting the number of LBT failures provided in an embodiment of the present disclosure.

FIG. 10 is a schematic flowchart of another method for counting the number of LBT failures provided in an embodiment of the present disclosure.

FIG. 11 is a schematic flow diagram of another method for counting the number of LBT failures provided in an embodiment of the present disclosure.

FIG. 12 is a schematic flow diagram of another method for counting the number of LBT failures provided in an embodiment of the present disclosure.

FIG. 13 is a schematic flow diagram of another method for counting the number of LBT failures provided in an embodiment of the present disclosure.

FIG. 14 is a schematic flow diagram of another method for counting the number of LBT failures provided in an embodiment of the present disclosure.

FIG. 15 is a schematic flow diagram of another method for counting the number of LBT failures provided in an embodiment of the present disclosure.

FIG. 16 is a schematic flow diagram of another method for counting the number of LBT failures provided in an embodiment of the present disclosure.

FIG. 17 is a schematic flow diagram of another method for counting the number of LBT failures provided in an embodiment of the present disclosure.

FIG. 18 is a schematic flow diagram of another method for counting the number of LBT failures provided in an embodiment of the present disclosure.

FIG. 19 is a schematic flow diagram of another method for counting the number of LBT failures provided in an embodiment of the present disclosure.

FIG. 20 is a schematic flow diagram of another method for counting the number of LBT failures provided in an embodiment of the present disclosure.

FIG. 21 is a schematic flow diagram of another method for counting the number of LBT failures provided in an embodiment of the present disclosure.

FIG. 22 is a schematic flow diagram of another method for counting the number of LBT failures provided in an embodiment of the present disclosure.

FIG. 23 is a schematic structural diagram of a communication device provided in an embodiment of the present disclosure.

FIG. 24 is a schematic structural diagram of another communication device provided in an embodiment of the present disclosure.

FIG. 25 is a schematic structural diagram of a chip provided in an embodiment of the present disclosure.

### DETAILED DESCRIPTION OF THE INVENTION

In order to better understand a method for counting the number of LBT failures disclosed in embodiments of the present disclosure, the following will first describe a communication system applicable to the embodiments of the present disclosure.

In sidelink communication, a sending terminal device sends sidelink control information (SCI) on a physical sidelink control channel (PSCCH) and a second-stage SCI on a physical sidelink shared channel (PSSCH). For a hybrid automatic repeat request (HARQ) feedback-enabled data packet, a receiving terminal device performs HARQ feedback for the PSSCH on a physical sidelink feedback channel (PSFCH). A LBT failure detection needs to be performed before sending the HARQ feedback on the PSFCH.

Please refer to FIG. 1, and FIG. 1 is a schematic architecture diagram of a communication system provided in an embodiment of the present disclosure. The communication system may include, but is not limited to one network device and one terminal device. The number and form of devices shown in FIG. 1 are merely for example and do not constitute a limitation on the embodiment of the present disclosure. In practical applications, the communication system may include two or more network devices and two or more terminal devices. The communication system shown in FIG. 1, including one network device 11 and one terminal device 12 is taken as an example.

It is to be noted that the technical solutions of the embodiments of the present disclosure may be applied to various communication systems, such as a long term evolution (LTE) system, a 5th generation (5G) mobile communication system, a 5G new radio (NR) system, or other future new mobile communication systems.

The network device 11 in the embodiments of the present disclosure is an entity on a network side for sending or receiving a signal. For example, the network device 101 may be an evolved NodeB (eNB), a transmission reception point (TRP), a next generation NodeB (gNB) in an NR system, base stations in other future mobile communication systems, or an access node in a wireless fidelity (WiFi) system, etc. A specific technology and a specific device form adopted by the network device are not limited by the embodiments of the present disclosure. The network device provided in the embodiment of the present disclosure may be composed of a central unit (CU) and a distributed unit (DU), where the CU may also be referred to as a control unit. A CU-DU structure may separate protocol layers of the network device, such as the base station. Some protocol layer functions placed in the CU for centralized control, and the remaining or all protocol layer functions distributed in the DU, and the CU centrally controls the DU.

The terminal device 12 in the embodiment of the present disclosure is an entity on a user side for receiving or sending a signal, such as a mobile phone. The terminal device may also be referred to as a terminal, a user equipment (UE), a mobile station (MS), or a mobile terminal (MT), etc. The terminal device may be a car with a communication function, a smart car, the mobile phone, a wearable device, a Pad, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home and the like. A specific technology and a specific device form adopted by the terminal device are not limited by the embodiments of the present disclosure.

It may be understood that the communication system described in the embodiments of the present disclosure is for the purpose of illustrating the technical solutions of the embodiments of the present disclosure more clearly, and does not constitute a limitation to the technical solutions provided in the embodiments of the present disclosure. Those ordinarily skilled in the art may know that with evolution of the system architecture and occurrence of a new service scenario, the technical solutions provided in the embodiments of the present disclosure are also applicable to the similar technical problem.

In sidelink communication, a sending terminal device sends sidelink control information (SCI) on a physical sidelink control channel (PSCCH) and a second-stage SCI on a physical sidelink shared channel (PSSCH). For a hybrid automatic repeat request (HARQ) feedback-enabled data packet, a receiving terminal device performs HARQ feedback for the PSSCH on a physical sidelink feedback channel (PSFCH). A LBT failure detection needs to be performed before sending the HARQ feedback on the PSFCH.

In a case where one HARQ-enabled PSSCH resource is associated with a plurality of PSFCH resources, the terminal device needs to perform the LBT before sending each PSFCH resource, and these PSFCH resources may be closely spaced. In a case where the terminal device counts the LBT failure for the plurality of continuous PSFCHs when counting the number of consistent LBT failures, the terminal device may frequently trigger sidelink consistent LBT failure, affecting communication quality of a link.

In the present disclosure, the terminal device may determine a number of LBT failures that continuously occur on the PSFCH associated with the HARQ-enabled PSSCH, and count a number of LBT failures for the PSFCH according to the number of LBT failures that continuously occur on the PSFCH associated with the HARQ-enabled PSSCH, to avoid frequent triggering of the sidelink consistent LBT failure and improve the communication quality of the link.

A method and device for counting the number of LBT failures provided in the present disclosure are described in detail below with reference to the accompanying drawings.

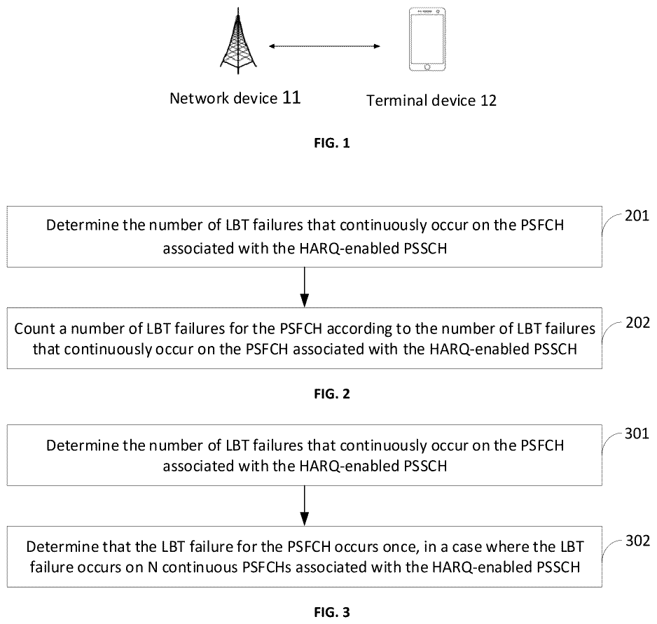

Please refer to FIG. 2, FIG. 2 is a schematic flowchart of a method for counting the number of LBT failures provided in an embodiment of the present disclosure, and the method is performed by the terminal device. As shown in FIG. 2, the method may include, but is not limited to the following steps.

Step 201, the number of LBT failures that continuously occur on the PSFCH associated with the HARQ-enabled PSSCH is determined.

In the present disclosure, the HARQ-enabled PSSCH may be understood as indicating the PSSCH that needs HARQ feedback. The HARQ-enabled PSSCH may be associated with a plurality of PSFCHs.

In the present disclosure, before performing the HARQ feedback on the PSFCH associated with the HARQ-enabled PSSCH, a LBT failure detection is performed to determine a number of PSFCHs on which the LBT failure occurs and which are associated with the HARQ-enabled PSSCH. The number of LBT failures that continuously occur on the PSFCH associated with the HARQ-enabled PSSCH is determined, according to the number of PSFCHs on which the LBT failure occurs and which are associated with the HARQ-enabled PSSCH.

For example, the HARQ-enabled PSSCH is associated with 5 PSFCHs, the LBT failure detection is performed before the HARQ feedback, in a case where the LBT failure occurs on 3 continuous PSFCHs, it may be determined that the number of LBT failures that continuously occur on the PSFCHs associated with the HARQ-enabled PSSCH is 3.

Step 202, a number of LBT failures for the PSFCH is counted according to the number of LBT failures that continuously occur on the PSFCH associated with the HARQ-enabled PSSCH.

In the present disclosure, in a case where the number of LBT failures that continuously occur on the PSFCH associated with the HARQ-enabled PSSCH is 1, it may be determined that the LBT failure for the PSFCH occurs once, so that the number of LBT failures for the PSFCH is counted. In a case where the HARQ-enabled PSSCH is associated with the plurality of PSFCHs, it may also be determined that the LBT failure for the PSFCH occurs once in a case where the number of LBT failures that continuously occur on the PSFCH associated with the HARQ-enabled PSSCH is multiple, so that the number of LBT failures for the PSFCH is counted.

Optionally, in a case where one PSSCH is associated with the plurality of PSFCHs, for a HARQ feedback-enabled sidelink media access control protocol data unit (MAC PDU), the terminal device may send the HARQ feedback on all PSFCHs associated with the PSSCH. In a case where the LBT failure occurs on N continuous PSFCHs associated with the PSSCH, resulting in HARQ transmission failure, the terminal device may determine that the LBT failure occurs once and count the number of LBT failures for the PSFCH as 1. A maximum value of N is the number of PSFCHs that may be associated with the PSSCH, and a minimum value of N is 1.

For example, for the PSFCH associated with the HARQ-enabled PSSCH, the LBT failure detection is performed before the HARQ feedback. In a case where a LBT failure indication submitted by a physical layer (PHY) is received, that is, the LBT failure occurs, it indicates that the PSFCH is occupied. In a case where the HARQ feedback is sent, it leads to HARQ feedback transmission failure.

In the embodiment of the present disclosure, by determining the number of LBT failures that continuously occur on the PSFCH associated with the HARQ-enabled PSSCH, and counting the number of LBT failures for the PSFCH according to the number of LBT failures that continuously occur on the PSFCH associated with the HARQ-enabled PSSCH, frequent triggering of the sidelink consistent LBT failure may be avoided, and communication quality of the link is improved.

Please refer to FIG. 3, FIG. 3 is a schematic flowchart of another method for counting the number of LBT failures provided in an embodiment of the present disclosure, and the method is performed by the terminal device. As shown in FIG. 3, the method may include, but is not limited to the following steps.

Step 301, the number of LBT failures that continuously occur on the PSFCH associated with the HARQ-enabled PSSCH is determined.

In the present disclosure, step 301 may be implemented in any manner of the embodiments in the present disclosure, respectively, which is not limited to the embodiments of the present disclosure and is not repeated.

Step 302, it is determined that the LBT failure for the PSFCH occurs once, in a case where the LBT failure occurs on N continuous PSFCHs associated with the HARQ-enabled PSSCH.

In the present disclosure, the HARQ-enabled PSSCH may be associated with the plurality of PSFCHs, for example, assuming that the number of PSFCHs associated with the HARQ-enabled PSSCH is M, where M is a positive integer greater than 1.

It may be determined that the LBT failure for the PSFCH occurs once, in a case where the LBT failure occurs on N continuous PSFCHs associated with the HARQ-enabled PSSCH. Where N is a positive integer less than or equal to M.

For example, a value of M is 6 and a value of N is 1, and the terminal device may determine that the LBT failure occurs once, in a case where the HARQ feedback failure is caused due to the LBT failure occurring on any PSFCH associated with the HARQ-enabled PSSCH. The value of N is 2, and the terminal device may determine that the LBT failure occurs once, in a case where the HARQ feedback failure is caused due to the LBT failure occurring on any two continuous PSFCHs associated with the HARQ-enabled PSSCH. The value of N is 6, and the terminal device may determine that the LBT failure occurs once, in a case where the LBT failure occurs on all PSFCHs associated with the HARQ-enabled PSSCH.

In a case where one HARQ-enabled PSSCH resource is associated with the plurality of PSFCH resources, the terminal device needs to perform the LBT before sending each PSFCH resource, and these PSFCH resources may be closely spaced. In a case where the terminal device counts the LBT failure for the plurality of continuous PSFCHs when counting the number of consistent LBT failures, the terminal device may frequently trigger the sidelink consistent LBT failure, affecting the communication quality of the link.

Based on this, in the present disclosure, the value of N may be greater than 1, that is, it is determined that the LBT failure occurs once in a case where the LBT failure occurs on the plurality of continuous PSFCHs associated with the HARQ-enabled PSSCH. This can solve the problem of the terminal device frequently triggering the sidelink consistent LBT failure and affecting the communication quality of the link, which is caused by counting the LBT failure for the plurality of continuous PSFCHs.

In the present disclosure, the value of N may be configured by the network device, pre-configured, or determined by the terminal device itself, which is not limited in the present disclosure.

In the present disclosure, for each HARQ-enabled PSSCH received on the resource pool, without distinguishing between unicast, multicast, or broadcast. The HARQ feedback is sent on the PSFCH resources associated with the PSSCH. In a case where the LBT failure occurs on N continuous PSFCH resources, the terminal device may consider that the continuous PSFCH LBT failure occurs once, and the terminal device starts or restarts a continuous PSFCH LBT failure detection timer, and increments a continuous PSFCH LBT failure detection counter by 1.

In addition, in a case where a number of LBT failures on the sidelink is counted, the number of LBT failures for the PSFCH may be counted in a mode of determining that the number of LBT failures for the PSFCH is 1 if the LBT failure occurs on N continuous PSFCHs associated with the HARQ-enabled PSSCH.

In the embodiment of the present disclosure, the number of LBT failures that continuously occur on the PSFCH associated with the HARQ-enabled PSSCH may be determined, and it is determined that the LBT failure for the PSFCH occurs once, in a case where the LBT failure occurs on the N continuous PSFCHs associated with the HARQ-enabled PSSCH. This may avoid frequent triggering of the sidelink consistent LBT failure and improve the quality of the communication of the link.

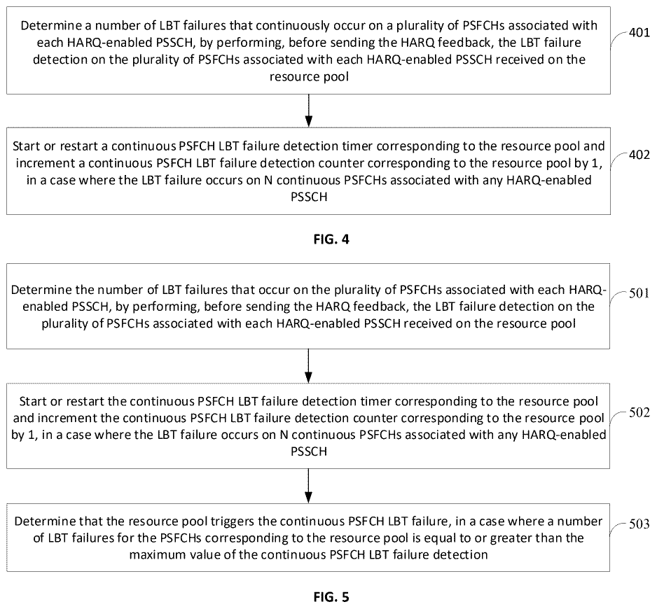

Please refer to FIG. 4, FIG. 4 is a schematic flowchart of another method for counting the number of LBT failures provided in an embodiment of the present disclosure, and the method is performed by the terminal device. As shown in FIG. 4, the method may include, but is not limited to the following steps.

Step 401, a number of LBT failures that continuously occur on a plurality of PSFCHs associated with each HARQ-enabled PSSCH is determined, by performing, before sending the HARQ feedback, the LBT failure detection on the plurality of PSFCHs associated with each HARQ-enabled PSSCH received on the resource pool.

In the present disclosure, an activated bandwidth part (BWP) is provided on an unlicensed frequency band, and one or more resource pools may be configured on the activated BWP. The terminal device may count the number of LBT failures for the PSFCH according to a granularity of the resource pool.

In the present disclosure, one or more HARQ-enabled PSSCHs may be received on the resource pool, and each HARQ-enabled PSSCH may be associated with the plurality of PSFCHs. The number of PSFCHs associated with different PSSCHs may be the same or different, which is not limited in the present disclosure.

In the present disclosure, a method of determining the number of LBT failures that continuously occur on the plurality of PSFCHs associated with each HARQ-enabled PSSCH, by performing, before sending the HARQ feedback, the LBT failure detection on the plurality of PSFCHs associated with each HARQ-enabled PSSCH received on the resource pool is similar to the above method of determining the number of LBT failures that continuously occur on the PSFCH associated with the HARQ-enabled PSSCH, which is not repeated here. Step 402, a continuous PSFCH LBT failure detection timer corresponding to the resource pool is started or restarted, and a continuous PSFCH LBT failure detection counter corresponding to the resource pool is incremented by 1, in a case where the LBT failure occurs on N continuous PSFCHs associated with any HARQ-enabled PSSCH.

In the present disclosure, in a case where the plurality of resource pools are configured on the BWP, a duration of the continuous PSFCH LBT failure detection timer used for each resource pool may be pre-configured or configured by the network device, which is not limited in the present disclosure.

Optionally, in the present disclosure, in a case where the terminal device is in a network coverage range, the terminal device may receive first configuration information sent by the network device, and determine at least one of: a continuous PSFCH LBT failure detection timer configured to count the number of LBT failures for the PSFCH on the resource pool; or a maximum value of a continuous PSFCH LBT failure detection, according to the first configuration information. The maximum value of the continuous PSFCH LBT failure detection is configured to determine whether the resource pool triggers the continuous PSFCH LBT failure.

Optionally, the first configuration information may include any one of: at least one of the continuous PSFCH LBT failure detection timer or a maximum value of the continuous PSFCH LBT failure detection corresponding to the resource pool; at least one of a continuous PSFCH LBT failure detection timer or a maximum value of the continuous PSFCH LBT failure detection corresponding to a bandwidth part (BWP) to which the resource pool belongs; or at least one of a continuous PSFCH LBT failure detection timer or a maximum value of the continuous PSFCH LBT failure detection corresponding to a cell to which the terminal device belongs.

In the present disclosure, the continuous PSFCH LBT failure detection timer used by the terminal device to count the number of LBT failures for the PSFCH on a certain resource pool may be the continuous PSFCH LBT failure detection timer corresponding to the resource pool in the first configuration information, or the continuous PSFCH LBT failure detection timer corresponding to the BWP to which the resource pool belongs, or the continuous PSFCH LBT failure detection timer corresponding to the cell to which the terminal device belongs. That is to say, at least one of the continuous PSFCH LBT failure detection timer or the maximum value of the continuous PSFCH LBT failure detection may be configured according to the granularity of the resource pool, or a granularity of the BWP, or a granularity of the cell.

Optionally, in the present disclosure, the first configuration information may be a dedicated radio resource control (RRC) signaling or a system information block (SIB) signaling, that is, the terminal device may obtain at least one of the continuous PSFCH LBT failure detection timer or the maximum value of the continuous PSFCH LBT failure detection via the dedicated RRC signaling or the SIB signaling.

Optionally, in a case where the terminal device is out of the network coverage range, at least one of the continuous PSFCH LBT failure detection timer or the maximum value of the continuous PSFCH LBT failure detection may be obtained via pre-configuration.

In the present disclosure, the resource pool may maintain one continuous PSFCH LBT failure detection counter, and an initial value of the continuous PSFCH LBT failure detection counter may be zero. In a case where the LBT failure occurs on N continuous PSFCHs associated with any HARQ-enabled PSSCH, the continuous PSFCH LBT failure detection timer corresponding to the resource pool may be started or restarted, and the continuous PSFCH LBT failure detection counter corresponding to the resource pool may be incremented by 1. During the running period of the continuous PSFCH LBT failure detection timer corresponding to the resource pool, for the plurality of PSFCHs associated with all HARQ-enabled PSSCHs received on the resource pool, a number of LBT failures counted by the continuous PSFCH LBT failure detection counter is the number of LBT failures for the PSFCH on the resource pool. N is an integer less than or equal to M, and M is the number of PSFCHs associated with the HARQ-enabled PSSCH.

In the present disclosure, the mode for the terminal device to obtain the value of N may be implemented using any manner in the embodiments of the present disclosure, which is not repeated here.

In the present disclosure, for each HARQ-enabled PSSCH received on the resource pool, without distinguishing between unicast, multicast, or broadcast. The HARQ feedback is sent on the PSFCH resources associated with the PSSCH. In a case where the LBT failure occurs on N continuous PSFCH resources, the terminal device may consider that the continuous PSFCH LBT failure occurs once, and the terminal device starts or restarts the continuous PSFCH LBT failure detection timer, and increments the continuous PSFCH LBT failure detection counter by 1.

Optionally, the continuous PSFCH LBT failure detection counter corresponding to the resource pool may be reset to be 0, in a case where at least one of the continuous PSFCH LBT failure detection timer corresponding to the resource pool or the maximum value of the continuous PSFCH LBT failure detection is reconfigured, to improve accuracy of counting the number of LBT failures for the PSFCH on the resource pool.

In addition, in a case where the number of LBT failures on a plurality of channels such as the PSSCH, the PSCCH, and the PSFCH associated with the resource pool is counted, the number of LBT failures for the PSFCH may be counted in a mode of determining that the number of LBT failures for the PSFCH is 1 if the LBT failure occurs on N continuous PSFCHs associated with any HARQ-enabled PSSCH.

In the embodiment of the present disclosure, the number of consistent LBT failures that occur on the plurality of PSFCHs associated with each HARQ-enabled PSSCH may be determined, by performing, before sending the HARQ feedback, the LBT failure detection on the plurality of PSFCHs associated with each HARQ-enabled PSSCH received on the resource pool. The continuous PSFCH LBT failure detection timer corresponding to the resource pool is started or restarted and the continuous PSFCH LBT failure detection counter corresponding to the resource pool is incremented by 1, in a case where the LBT failure occurs on N continuous PSFCHs associated with any HARQ-enabled PSSCH. Thus, the number of LBT failures for the PSFCH may be counted according to the granularity of the resource pool.

Please refer to FIG. 5, FIG. 5 is a schematic flowchart of another method for counting the number of LBT failures provided in an embodiment of the present disclosure, and the terminal device performs the method. As shown in FIG. 5, the method may include, but is not limited to the following steps.

Step 501, the number of LBT failures that occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the resource pool.

Step 502, the continuous PSFCH LBT failure detection timer corresponding to the resource pool is started or restarted, and a continuous PSFCH LBT failure detection counter corresponding to the resource pool is incremented by 1, in a case where the LBT failure occurs on N continuous PSFCHs associated with any HARQ-enabled PSSCH.

In the present disclosure, steps 501 and 502 may be implemented in any manner of the embodiments in the present disclosure, respectively, which are not limited to the embodiments of the present disclosure and are not repeated.

Step 503, it is determined that the resource pool triggers the continuous PSFCH LBT failure, in a case where a number of LBT failures for the PSFCHs corresponding to the resource pool is equal to or greater than the maximum value of the continuous PSFCH LBT failure detection.

In the present disclosure, it may be determined that the resource pool triggers the continuous PSFCH LBT failure, in a case where the number of LBT failures for the PSFCHs corresponding to the resource pool is greater than or equal to the maximum value of the continuous PSFCH LBT failure detection. The maximum value of the continuous PSFCH LBT failure detection may be pre-configured or configured by the network device, which is not limited in the present disclosure.

Optionally, in the present disclosure, in a case where the plurality of resource pools are configured on the BWP, the number of LBT failures for the PSFCH on each resource pool may be determined by using the above method. Whether each resource pool triggers the continuous PSFCH LBT failure may be determined according to the maximum value of the continuous PSFCH LBT failure detection corresponding to each resource pool. The maximum value of the continuous PSFCH LBT failure detection configured to determine whether each resource pool triggers the continuous PSFCH LBT failure may be configured by the network device, as described above, or pre-configured, which is not limited in the present disclosure.

Optionally, the maximum value of the continuous PSFCH LBT failure detection used by the terminal device to determine whether the certain resource pool triggers the continuous PSFCH LBT failure may be the maximum value of the continuous PSFCH LBT failure detection corresponding to the resource pool in the first configuration information, or the maximum value of the continuous PSFCH LBT failure detection corresponding to the BWP to which the resource pool belongs, or the maximum value of the continuous PSFCH LBT failure detection corresponding to the cell to which the terminal device belongs. That is to say, the maximum value of the continuous PSFCH LBT failure detection may be configured according to the granularity of the resource pool, or the granularity of the BWP, or the granularity of the cell.

In the embodiment of the present disclosure, the number of LBT failures for the PSFCH on the resource pool may be counted by using the continuous PSFCH LBT failure detection timer corresponding to the resource pool. It is determined that the resource pool triggers the continuous PSFCH LBT failure, in a case where the number of LBT failures for the PSFCHs corresponding to the resource pool is equal to or greater than the maximum value of the continuous PSFCH LBT failure detection. Thus, it is possible to count the number of LBT failures for the PSFCHs according to the granularity of the resource pool, and determine whether the resource pool triggers the continuous PSFCH LBT failure according to the number of LBT failures for the PSFCHs on the resource pool and the maximum value of the continuous PSFCH LBT failure detection.

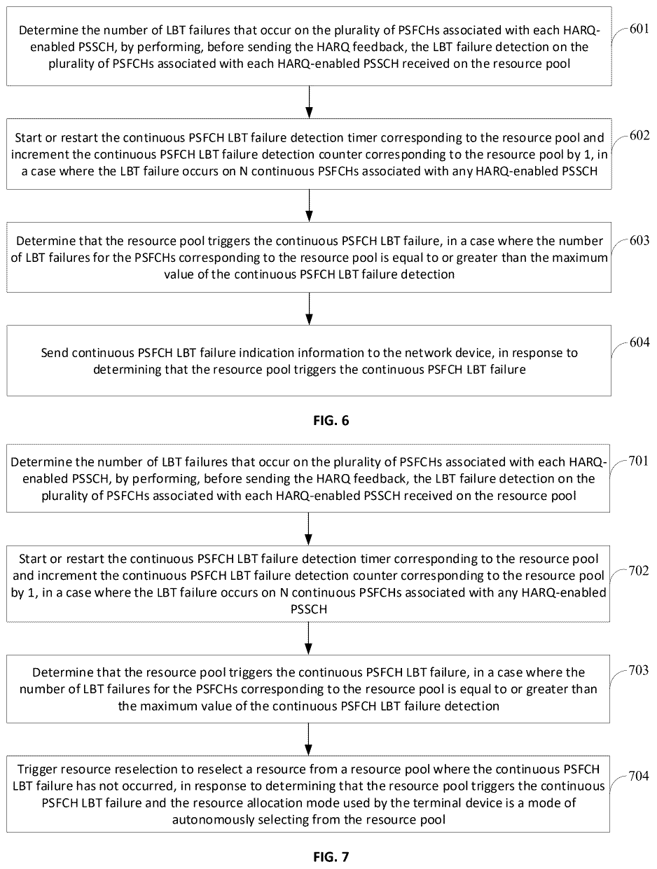

Please refer to FIG. 6, FIG. 6 is a schematic flowchart of another method for counting the number of LBT failures provided in an embodiment of the present disclosure, and the method is performed by the terminal device. As shown in FIG. 6, the method may include, but is not limited to the following steps.

Step 601, the number of LBT failures that occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the resource pool.

Step 602, the continuous PSFCH LBT failure detection timer corresponding to the resource pool is started or restarted, and the continuous PSFCH LBT failure detection counter corresponding to the resource pool is incremented by 1, in a case where the LBT failure occurs on N continuous PSFCHs associated with any HARQ-enabled PSSCH.

Step 603, it is determined that the resource pool triggers the continuous PSFCH LBT failure, in a case where the number of LBT failures for the PSFCHs corresponding to the resource pool is equal to or greater than the maximum value of the continuous PSFCH LBT failure detection.

In the present disclosure, step 601 to step 603 may be implemented in any manner of the embodiments in the present disclosure respectively, which is not limited in the embodiments of the present disclosure and is not repeated.

In step 604, continuous PSFCH LBT failure indication information is sent to the network device in response to determining that the resource pool triggers the continuous PSFCH LBT failure. In the present disclosure, the terminal device may send the continuous PSFCH LBT failure indication information to the network device in response to determining that the resource pool triggers the continuous PSFCH LBT failure, to notify the network device that the continuous PSFCH LBT failure occurs on the resource pool.

The continuous PSFCH LBT failure indication information may include indication information of the resource pool, such as an identifier of the resource pool. Thus, the network device may determine which resource pool has occurred the continuous PSFCH LBT failure according to the continuous PSFCH LBT failure indication information.

Optionally, in sidelink communication, allocation modes for a sending resource may include a mode of network dynamic scheduling, a mode that the terminal device autonomously selects from a resource pool broadcasted on a network, and so on.

Optionally, the terminal device is a terminal device with the resource allocation mode of network dynamic scheduling, or a terminal device with the mode of autonomously selecting from the resource pool in a radio resource control (RRC) connection state. The continuous PSFCH LBT failure indication information may be sent to the network device, in response to determining that the resource pool triggers the continuous PSFCH LBT failure.

Optionally, in the present disclosure, the continuous PSFCH LBT failure indication information may be a media access control control element (MAC CE) or the RRC signaling, etc., which is not limited in the present disclosure.

It is to be noted that in the present disclosure, whether the resource pool triggers the continuous PSFCH LBT failure may be determined using the mode in the above step 601 to step 603, or other modes, which is not limited in the present disclosure.

In the embodiment of the present disclosure, the number of LBT failures for the PSFCH may be counted according to the granularity of the resource pool. Whether the resource pool triggers the continuous PSFCH LBT failure may be determined according to the number of LBT failures for the PSFCH on the resource pool and the maximum value of the continuous PSFCH LBT failure detection. The continuous PSFCH LBT failure indication information may be sent to the network device in response to determining that the resource pool triggers the continuous PSFCH LBT failure and to notify the network device that the continuous PSFCH LBT failure occurs on the resource pool.

Please refer to FIG. 7, FIG. 7 is a schematic flowchart of another method for counting the number of LBT failures provided in an embodiment of the present disclosure, and the method is performed by the terminal device. As shown in FIG. 7, the method may include, but is not limited to the following steps.

Step 701, the number of LBT failures that occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the resource pool.

Step 702, the continuous PSFCH LBT failure detection timer corresponding to the resource pool is started or restarted, and the continuous PSFCH LBT failure detection counter corresponding to the resource pool is incremented by 1, in a case where the LBT failure occurs on N continuous PSFCHs associated with any HARQ-enabled PSSCH.

Step 703, it is determined that the resource pool triggers the continuous PSFCH LBT failure, in a case where the number of LBT failures for the PSFCHs corresponding to the resource pool is equal to or greater than the maximum value of the continuous PSFCH LBT failure detection.

In the present disclosure, step 701 to step 703 may be implemented in any manner of the embodiments in the present disclosure respectively, which is not limited in the embodiments of the present disclosure and is not repeated.

Step 704, resource reselection is triggered to reselect a resource form a resource pool where the continuous PSFCH LBT failure has not occurred, in response to determining that the resource pool triggers the continuous PSFCH LBT failure and the resource allocation mode used by the terminal device is a mode of autonomously selecting from the resource pool.

There are two allocation modes for sending resources in sidelink communication: one is a mode of network dynamic scheduling, and the other is a mode that the terminal device autonomously selects from a resource pool broadcasted on a network or a resource block set.

In the present disclosure, in a case where the terminal device determines that the resource pool triggers the continuous PSFCH LBT failure and the resource allocation mode used by the terminal device is the mode of autonomously selecting from the resource pool, the terminal device may trigger resource reselection to reselect the resource form the resource pool where the continuous PSFCH LBT failure has not occurred, to perform the HARQ feedback using a reselected resource.

It is to be noted that in the present disclosure, whether the resource pool triggers the continuous PSFCH LBT failure may be determined using the mode in the above step 701 to step 703, or other modes, which is not limited in the present disclosure.

In the embodiment of the present disclosure, the number of LBT failures for the PSFCH may be counted according to the granularity of the resource pool. Whether the resource pool triggers the continuous PSFCH LBT failure may be determined according to the number of LBT failures for the PSFCH on the resource pool and the maximum value of the continuous PSFCH LBT failure detection. The resource reselection may be triggered to reselect the resource from the resource pool where the continuous PSFCH LBT failure has not occurred, in response to determining that the resource pool triggers the continuous PSFCH LBT failure and the resource allocation mode used by the terminal device is the mode of autonomously selecting from the resource pool, to perform the HARQ feedback using the reselected resource. Thus, a transmission success rate of the HARQ feedback is increased.

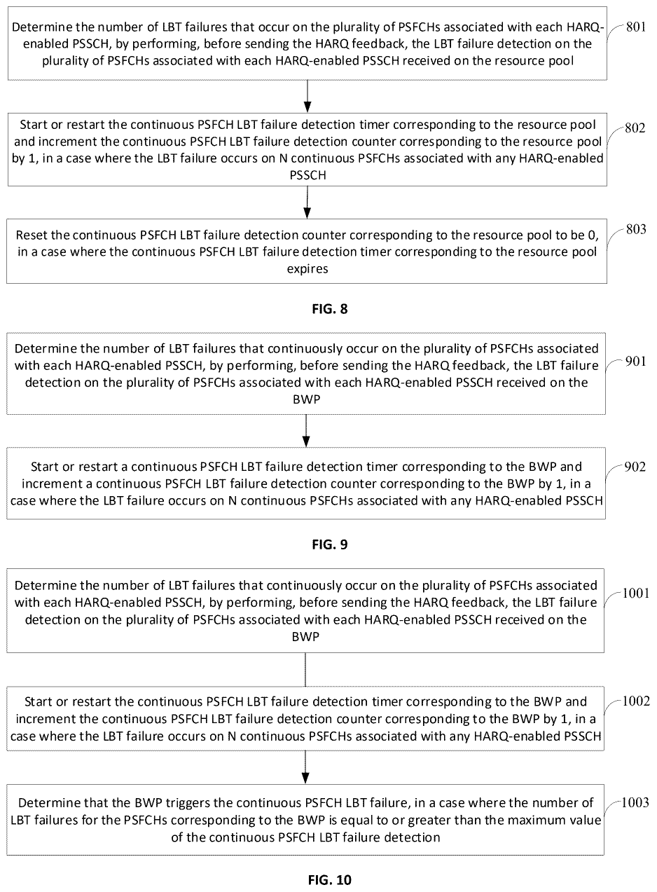

Please refer to FIG. 8, FIG. 8 is a schematic flowchart of another method for counting the number of LBT failures provided in an embodiment of the present disclosure, and the method is performed by the terminal device. As shown in FIG. 8, the method may include, but is not limited to the following steps.

Step 801, the number of LBT failures that occur on the plurality of PSFCHs associated with each HARQ-enabled PSSCH is determined, by performing, before sending HARQ feedback, the LBT failure detection on the plurality of PSFCHs associated with each HARQ-enabled PSSCH received on the resource pool.

Step 802, the continuous PSFCH LBT failure detection timer corresponding to the resource pool is started or restarted, and the continuous PSFCH LBT failure detection counter corresponding to the resource pool is incremented by 1, in a case where the LBT failure occurs on N continuous PSFCHs associated with any HARQ-enabled PSSCH.

In the present disclosure, steps 801 and 802 may be implemented in any manner of the embodiments in the present disclosure, respectively, which is not limited to the embodiments of the present disclosure and is not repeated.

Step 803, the continuous PSFCH LBT failure detection counter corresponding to the resource pool is reset to be 0, in a case where the continuous PSFCH LBT failure detection timer corresponding to the resource pool expires.

In the present disclosure, a duration of the continuous PSFCH LBT failure detection timer corresponding to the resource pool may be set by the network device or pre-configured, which is not limited in the present disclosure.

In the present disclosure, the continuous PSFCH LBT failure detection counter corresponding to the resource pool may be reset to be 0, in a case where the continuous PSFCH LBT failure detection timer corresponding to the resource pool expires, to recount the number of LBT failures for the PSFCH on the resource pool next time when the resource pool meets a counting condition of the number of LBT failures for the PSFCH.

In the embodiment of the present disclosure, the number of LBT failures for the PSFCH may be counted according to the granularity of the resource pool. The continuous PSFCH LBT failure detection counter corresponding to the resource pool may be reset to be 0, in a case where the continuous PSFCH LBT failure detection timer corresponding to the resource pool expires, to recount the number of LBT failures for the PSFCH on the resource pool next time when the resource pool meets the counting condition of the number of LBT failures for the PSFCH. Thus, accuracy of the number of LBT failures for the PSFCH on the resource pool is improved.

Please refer to FIG. 9, FIG. 9 is a schematic flowchart of another method for counting the number of LBT failures provided in an embodiment of the present disclosure, and the method is performed by the terminal device. As shown in FIG. 9, the method may include, but is not limited to the following steps.

Step 901, the number of LBT failures that continuously occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the BWP.

In the present disclosure, one or more HARQ-enabled PSSCHs may be received on the BWP, and each HARQ-enabled PSSCH may be associated with the plurality of PSFCHs. The number of PSFCHs associated with different PSSCHs may be the same or different, which is not limited in the present disclosure.

In the present disclosure, a method of determining the number of LBT failures that continuously occur on the plurality of PSFCHs associated with each HARQ-enabled PSSCH, by performing, before sending the HARQ feedback, the LBT failure detection on the plurality of PSFCHs associated with each HARQ-enabled PSSCH received on the BWP is similar to the above method of determining the number of LBT failures that continuously occur on the PSFCH associated with the HARQ-enabled PSSCH, which is not repeated here.

Step 902, a continuous PSFCH LBT failure detection timer corresponding to the BWP is started or restarted and a continuous PSFCH LBT failure detection counter corresponding to the BWP is incremented by 1, in a case where the LBT failure occurs on N continuous PSFCHs associated with any HARQ-enabled PSSCH.

In the present disclosure, a duration of the continuous PSFCH LBT failure detection timer for the BWP may be pre-configured or configured by the network device, which is not limited in the present disclosure.

Optionally, in the present disclosure, in a case where the terminal device is in the network coverage range, the terminal device may receive second configuration information sent by the network device, and determine at least one of: a continuous PSFCH LBT failure detection timer configured to count the number of PSFCH LBT failures on the BWP; or a maximum value of the continuous PSFCH LBT failure detection, according to the second configuration information. The maximum value of the continuous PSFCH LBT failure detection is configured to determine whether the BWP triggers the continuous PSFCH LBT failure.

In the present disclosure, the second configuration information includes any one of: at least one of the continuous PSFCH LBT failure detection timer or the maximum value of the continuous PSFCH LBT failure detection corresponding to the BWP; or at least one of the continuous PSFCH LBT failure detection timer or the maximum value of the continuous PSFCH LBT failure detection corresponding to the cell to which the terminal device belongs.

In the present disclosure, the continuous PSFCH LBT failure detection timer used by the terminal device to count the number of LBT failures for the PSFCH on the certain BWP may be the continuous PSFCH LBT failure detection timer corresponding to the BWP, or the continuous PSFCH LBT failure detection timer corresponding to the cell to which the terminal device belongs. That is to say, at least one of the continuous PSFCH LBT failure detection timer or the maximum value of the continuous PSFCH LBT failure detection may be configured according to the granularity of the BWP, or the granularity of the cell.

Optionally, in the present disclosure, the second configuration information may be the dedicated RRC signaling or the SIB signaling, that is, the terminal device may obtain at least one of the continuous PSFCH LBT failure detection timer or the maximum value of the continuous PSFCH LBT failure detection via the dedicated RRC signaling or the SIB signaling.

Optionally, in a case where the terminal device is out of the network coverage range, at least one of the continuous PSFCH LBT failure detection timer or the maximum value of the continuous PSFCH LBT failure detection may be obtained via pre-configuration.

In the present disclosure, the BWP may maintain one continuous PSFCH LBT failure detection counter, and the initial value of the continuous PSFCH LBT failure detection counter may be zero. In a case where the LBT failure occurs on N continuous PSFCHs associated with any HARQ-enabled PSSCH, the continuous PSFCH LBT failure detection timer corresponding to the BWP may be started or restarted, and the continuous PSFCH LBT failure detection counter corresponding to the BWP may be incremented by 1. During the running period of the continuous PSFCH LBT failure detection timer corresponding to the BWP, for the plurality of PSFCHs associated with all HARQ-enabled PSSCHs received on the BWP, the number of LBT failures counted by the continuous PSFCH LBT failure detection counter is the number of LBT failures for the PSFCH on the BWP. N is an integer less than or equal to M, and M is the number of PSFCHs associated with the HARQ-enabled PSSCH.

In the present disclosure, the mode for the terminal device to obtain the value of N may be implemented in any manner in the embodiments of the present disclosure, which is not limited to the embodiment of the present disclosure and is not repeated here.

In the present disclosure, for each HARQ-enabled PSSCH received on the BWP, without distinguishing between unicast, multicast, or broadcast. The HARQ feedback is sent on the PSFCH resource associated with the PSSCH. In a case where the LBT failure occurs on N continuous PSFCH resources, the terminal device may consider that the continuous PSFCH LBT failure occurs once, and the terminal device starts or restarts the continuous PSFCH LBT failure detection timer, and increments the continuous PSFCH LBT failure detection counter by 1.

Optionally, the continuous PSFCH LBT failure detection counter corresponding to the BWP may be reset to be 0, in a case where at least one of the continuous PSFCH LBT failure detection timer corresponding to the BWP or the maximum value of the continuous PSFCH LBT failure detection is reconfigured, to improve accuracy of counting the number of LBT failures for the PSFCH on the BWP.

In addition, in a case where the number of LBT failures on the plurality of channels such as the PSSCH, the PSCCH, and the PSFCH associated with all resource pools on the BWP is counted, the number of LBT failures for the PSFCH may be counted in a mode of determining that the number of LBT failures for the PSFCH is 1 if the LBT failure occurs on N continuous PSFCHs associated with any HARQ-enabled PSSCH.

In the embodiment of the present disclosure, the number of consistent LBT failures that occur on the plurality of PSFCHs associated with each HARQ-enabled PSSCH may be determined, by performing, before sending the HARQ feedback, the LBT failure detection on the plurality of PSFCHs associated with each HARQ-enabled PSSCH received on the BWP. The continuous PSFCH LBT failure detection timer corresponding to the BWP is started or restarted and the continuous PSFCH LBT failure detection counter corresponding to the BWP is incremented by 1, in a case where the LBT failure occurs on N continuous PSFCHs associated with any HARQ-enabled PSSCH. Thus, the number of LBT failures for the PSFCH may be counted according to the granularity of the BWP.

Please refer to FIG. 10, FIG. 10 is a schematic flowchart of another method for counting the number of LBT failures provided in an embodiment of the present disclosure, and the method is performed by the terminal device. As shown in FIG. 10, the method may include, but is not limited to the following steps.

Step 1001, the number of LBT failures that continuously occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the BWP.

Step 1002, the continuous PSFCH LBT failure detection timer corresponding to the BWP is started or restarted and the continuous PSFCH LBT failure detection counter corresponding to the BWP is incremented by 1, in a case where the LBT failure occurs on N continuous PSFCHs associated with any HARQ-enabled PSSCH.

In the present disclosure, steps 1001 and 1002 may be implemented in any manner of the embodiments in the present disclosure, respectively, which are not limited to the embodiments of the present disclosure and are not repeated.

Step 1003, it is determined that the BWP triggers the continuous PSFCH LBT failure, in a case where the number of LBT failures for the PSFCHs corresponding to the BWP is equal to or greater than the maximum value of the continuous PSFCH LBT failure detection.

In the present disclosure, it may be determined that the BWP triggers the continuous PSFCH LBT failure in a case where the number of LBT failures for the PSFCHs corresponding to the BWP is greater than or equal to the maximum value of the continuous PSFCH LBT failure detection. The maximum value of the continuous PSFCH LBT failure detection may be pre-configured or configured by the network device, which is not limited in the present disclosure.

Optionally, the terminal device may obtain the second configuration information sent by the network device, and determine the maximum value of the continuous PSFCH LBT failure detection according to the second configuration information.

In the present disclosure, for an explanation and description of the second configuration information, reference may be made to the above embodiments, which is not repeated here.

Optionally, the maximum value of the continuous PSFCH LBT failure detection used by the terminal device to determine whether the BWP triggers the continuous PSFCH LBT failure may be the maximum value of the continuous PSFCH LBT failure detection corresponding to the BWP in the second configuration information, or the maximum value of the continuous PSFCH LBT failure detection corresponding to the cell to which the terminal device belongs. That is to say, the maximum value of the continuous PSFCH LBT failure detection may be configured according to the granularity of the BWP, or the granularity of the cell.

In the embodiment of the present disclosure, the number of LBT failures for the PSFCH on the BWP may be counted by using the continuous PSFCH LBT failure detection timer corresponding to the BWP. It is determined that the BWP triggers the continuous PSFCH LBT failure in a case where the number of LBT failures for the PSFCHs corresponding to the BWP is equal to or greater than the maximum value of the continuous PSFCH LBT failure detection. Thus, the number of LBT failures for the PSFCH may be counted according to the granularity of the BWP, and whether the BWP triggers the continuous PSFCH LBT failure may be determined according to the number of LBT failures for the PSFCH on the BWP and the maximum value of the continuous PSFCH LBT failure detection.

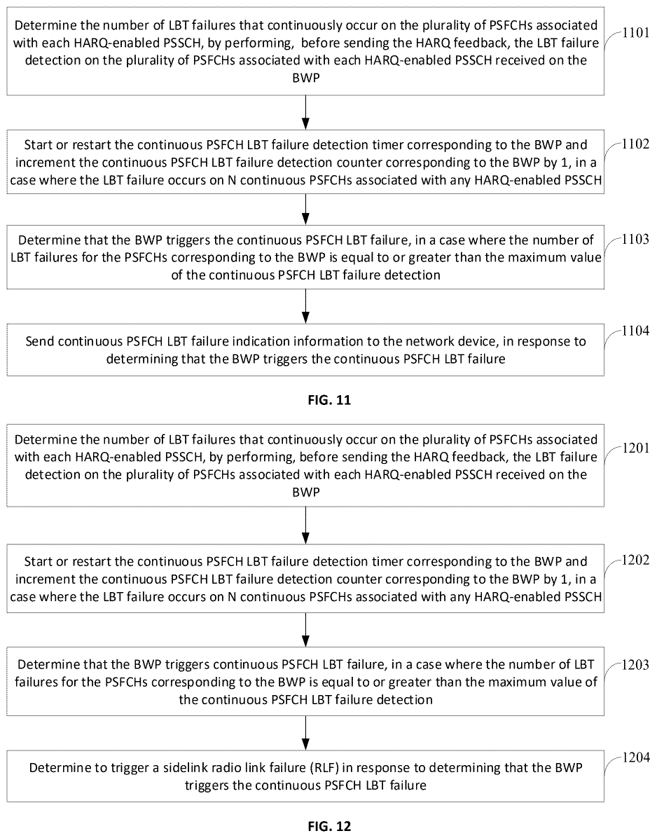

Please refer to FIG. 11, FIG. 11 is a schematic flowchart of another method for counting the number of LBT failures provided in an embodiment of the present disclosure, and the method is performed by the terminal device. As shown in FIG. 11, the method may include, but is not limited to the following steps.

Step 1101, the number of LBT failures that continuously occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the BWP.

Step 1102, the continuous PSFCH LBT failure detection timer corresponding to the BWP is started or restarted, and the continuous PSFCH LBT failure detection counter corresponding to the BWP is incremented by 1, in a case where the LBT failure occurs on N continuous PSFCHs associated with any HARQ-enabled PSSCH.

Step 1103, it is determined that the BWP triggers the continuous PSFCH LBT failure, in a case where the number of LBT failures for the PSFCHs corresponding to the BWP is equal to or greater than the maximum value of the continuous PSFCH LBT failure detection.

In the present disclosure, step 1101 to step 1103 may be implemented in any manner of the embodiments in the present disclosure respectively, which is not limited in the embodiments of the present disclosure and is not repeated.

Step 1104, continuous PSFCH LBT failure indication information is sent to the network device, in response to determining that the BWP triggers the continuous PSFCH LBT failure.

In the present disclosure, the terminal device may send the continuous PSFCH LBT failure indication information to the network device in response to determining that the BWP triggers the continuous PSFCH LBT failure, to notify the network device that the continuous PSFCH LBT failure occurs on the BWP.

The continuous PSFCH LBT failure indication information may include indication information of the BWP, such as identifier of the BWP. Thus, the network device may determine that the continuous PSFCH LBT failure occurs on the BWP according to the continuous PSFCH LBT failure indication information.

Optionally, in the present disclosure, the continuous PSFCH LBT failure indication information may be the MAC CE or the RRC signaling, etc., which is not limited in the present disclosure.

It is to be noted that in the present disclosure, whether the BWP triggers the continuous PSFCH LBT failure may be determined using the manner in the above step 1101 to step 1103, or other manners, which is not limited in the present disclosure.

In the embodiment of the present disclosure, the number of LBT failures for the PSFCH may be counted according to the granularity of the BWP. Whether the BWP triggers the continuous PSFCH LBT failure may be determined according to the number of LBT failures for the PSFCH on the BWP and the maximum value of the continuous PSFCH LBT failure detection. The continuous PSFCH LBT failure indication information may be sent to the network device in response to determining that the BWP triggers the continuous PSFCH LBT failure and to notify the network device that the continuous PSFCH LBT failure occurs on the BWP.

Please refer to FIG. 12, FIG. 12 is a schematic flowchart of another method for counting the number of LBT failures provided in an embodiment of the present disclosure, and the method is performed by the terminal device. As shown in FIG. 12, the method may include, but is not limited to the following steps.

Step 1201, the number of LBT failures that continuously occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the BWP.

Step 1202, the continuous PSFCH LBT failure detection timer corresponding to the BWP is started or restarted, and the continuous PSFCH LBT failure detection counter corresponding to the BWP is incremented by 1, in a case where the LBT failure occurs on N continuous PSFCHs associated with any HARQ-enabled PSSCH.

Step 1203, it is determined that the BWP triggers the continuous PSFCH LBT failure, in a case where the number of LBT failures for the PSFCHs corresponding to the BWP is equal to or greater than the maximum value of the continuous PSFCH LBT failure detection.

In the present disclosure, step 1201 to step 1203 may be implemented in any manner of the embodiments in the present disclosure respectively, which is not limited in the embodiments of the present disclosure and is not repeated.

Step 1204, it is determined to trigger a sidelink radio link failure (RLF) in response to determining that the BWP triggers the continuous PSFCH LBT failure.

In the present disclosure, in response to determining that the BWP triggers the continuous PSFCH LBT failure, the terminal device may determine to trigger the sidelink radio link failure (RLF).

It is to be noted that in the present disclosure, whether the BWP triggers the continuous PSFCH LBT failure may be determined using the manner in the above step 1201 to step 1203, or other manners, which is not limited in the present disclosure.

In the embodiment of the present disclosure, the number of LBT failures for the PSFCH may be counted according to the granularity of the BWP. Whether the BWP triggers the continuous PSFCH LBT failure may be determined according to the number of LBT failures for the PSFCH on the BWP and the maximum value of the continuous PSFCH LBT failure detection, and it is determined to trigger the sidelink RLF in response to determining that the BWP triggers the continuous PSFCH LBT failure, which can enable timely reconnection and communication between the terminal devices.

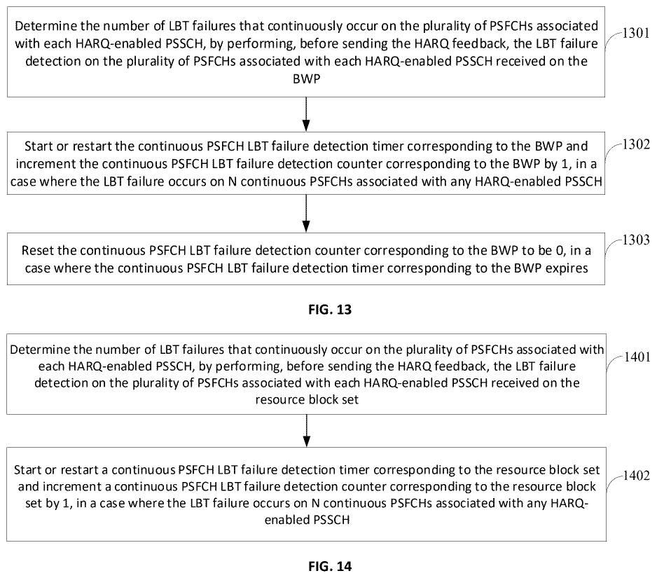

Please refer to FIG. 13, FIG. 13 is a schematic flowchart of another method for counting the number of LBT failures provided in an embodiment of the present disclosure, and the method is performed by the terminal device. As shown in FIG. 13, the method may include, but is not limited to the following steps.

Step 1301, the number of LBT failures that continuously occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the BWP.

Step 1302, the continuous PSFCH LBT failure detection timer corresponding to the BWP is started or restarted and the continuous PSFCH LBT failure detection counter corresponding to the BWP is incremented by 1, in a case where the LBT failure occurs on N continuous PSFCHs associated with any HARQ-enabled PSSCH.

In the present disclosure, step 1301 to step 1302 may be implemented in any manner of the embodiments in the present disclosure respectively, which is not limited in the embodiments of the present disclosure and is not repeated.

Step 1303, the continuous PSFCH LBT failure detection counter corresponding to the BWP is reset to be 0, in a case where the continuous PSFCH LBT failure detection timer corresponding to the BWP expires.

In the present disclosure, a duration of the continuous PSFCH LBT failure detection timer corresponding to the BWP may be set by the network device or pre-configured, which is not limited in the present disclosure.

In the present disclosure, the continuous PSFCH LBT failure detection counter corresponding to the BWP may be reset to be 0, in a case where the continuous PSFCH LBT failure detection timer corresponding to the BWP expires, to recount the number of LBT failures for the PSFCH on the BWP next time when the BWP meets a counting condition of the number of LBT failures for the PSFCH.

In the embodiment of the present disclosure, the number of LBT failures for the PSFCH may be counted according to the granularity of the BWP. The continuous PSFCH LBT failure detection counter corresponding to the BWP may be reset to be 0, in a case where the continuous PSFCH LBT failure detection timer corresponding to the BWP expires, to recount the number of LBT failures for the PSFCH on the BWP next time when the BWP meets the counting condition of the number of LBT failures for the PSFCH. Thus, accuracy of the number of LBT failures for the PSFCH on the BWP is improved.

Please refer to FIG. 14, FIG. 14 is a schematic flowchart of another method for counting the number of LBT failures provided in an embodiment of the present disclosure, and the method is performed by the terminal device. As shown in FIG. 14, the method may include, but is not limited to the following steps.

Step 1401, the number of LBT failures that continuously occur on the plurality of PSFCHs associated with each HARQ-enabled PSSCH is determined, by performing, before the sending HARQ feedback, the LBT failure detection on the plurality of PSFCHs associated with each HARQ-enabled PSSCH received on the resource block set.

In the present disclosure, the activated BWP is provided on the unlicensed frequency band, and one or more resource block sets may be configured on the activated BWP. The terminal device may count the number of LBT failures for the PSFCH according to the granularity of the resource block set.

In the present disclosure, one or more HARQ-enabled PSSCHs may be received on the resource block set, and each HARQ-enabled PSSCH may be associated with the plurality of PSFCHs. The number of PSFCHs associated with different PSSCHs may be the same or different, which is not limited in the present disclosure.

In the present disclosure, a method of determining the number of LBT failures that continuously occur on the plurality of PSFCHs associated with each HARQ-enabled PSSCH, by performing, before sending the HARQ feedback, the LBT failure detection on the plurality of PSFCHs associated with each HARQ-enabled PSSCH received on the resource block set is similar to the above method of determining the number of LBT failures that continuously occur on the PSFCH associated with the HARQ-enabled PSSCH, which is not repeated here.

Step 1402, a continuous PSFCH LBT failure detection timer corresponding to the resource block set is started or restarted and a continuous PSFCH LBT failure detection counter corresponding to the resource block set is incremented by 1, in a case where the LBT failure occurs on N continuous PSFCHs associated with any HARQ-enabled PSSCH.

In the present disclosure, a duration of the continuous PSFCH LBT failure detection timer for the resource block set may be pre-configured or configured by the network device, which is not limited in the present disclosure.

Optionally, in the present disclosure, in a case where the terminal device is in the network coverage range, the terminal device may receive third configuration information sent by the network device, and determine at least one of: a continuous PSFCH LBT failure detection timer configured to count the number of LBT failures for the PSFCH on the resource block set; or a maximum value of the continuous PSFCH LBT failure detection, according to the third configuration information. The maximum value of the continuous PSFCH LBT failure detection is configured to determine whether the resource block set triggers the continuous PSFCH LBT failure.

In the present disclosure, the third configuration information includes any one of: at least one of the continuous PSFCH LBT failure detection timer or a maximum value of the continuous PSFCH LBT failure detection corresponding to the resource block set; at least one of a continuous PSFCH LBT failure detection timer or a maximum value of the continuous PSFCH LBT failure detection corresponding to a BWP to which the resource block set belongs; or at least one of a continuous PSFCH LBT failure detection timer or a maximum value of the continuous PSFCH LBT failure detection corresponding to a cell to which the terminal device belongs.

In the present disclosure, the continuous PSFCH LBT failure detection timer used by the terminal device to count the number of LBT failures for the PSFCH on a certain resource block set may be the continuous PSFCH LBT failure detection timer corresponding to the resource block set, or the continuous PSFCH LBT failure detection timer corresponding to the cell to which the terminal device belongs. That is to say, at least one of the continuous PSFCH LBT failure detection timer or the maximum value of the continuous PSFCH LBT failure detection may be configured according to the granularity of the resource block set, or the granularity of the BWP, or the granularity of the cell.

Optionally, in the present disclosure, the third configuration information may be the dedicated RRC signaling or the SIB signaling, that is, the terminal device may obtain at least one of the continuous PSFCH LBT failure detection timer or the maximum value of the continuous PSFCH LBT failure detection via the dedicated RRC signaling or the SIB signaling.

Optionally, in a case where the terminal device is out of the network coverage range, at least one of the continuous PSFCH LBT failure detection timer or the maximum value of the continuous PSFCH LBT failure detection may be obtained via pre-configuration.

In the present disclosure, the resource block set may maintain one continuous PSFCH LBT failure detection counter, and the initial value of the continuous PSFCH LBT failure detection counter may be zero. In a case where the LBT failure occurs on N continuous PSFCHs associated with any HARQ-enabled PSSCH, the continuous PSFCH LBT failure detection timer corresponding to the resource block set may be started or restarted, and the continuous PSFCH LBT failure detection counter corresponding to the resource block set may be incremented by 1. During the running period of the continuous PSFCH LBT failure detection timer corresponding to the resource block set, for the plurality of PSFCHs associated with all HARQ-enabled PSSCHs received on the resource block set, the number of LBT failures counted by the continuous PSFCH LBT failure detection counter is the number of LBT failures for the PSFCH on the resource block set. N is an integer less than or equal to M, and M is the number of PSFCHs associated with the HARQ-enabled PSSCH.

In the present disclosure, the value of N may be configured by the network device, pre-configured, or determined by the terminal device itself, which is not limited in the present disclosure.

In the present disclosure, for each HARQ-enabled PSSCH received on the resource block set, without distinguishing between unicast, multicast, or broadcast. The HARQ feedback is sent on the PSFCH resource associated with the PSSCH. In a case where the LBT failure occurs on N continuous PSFCH resources, the terminal device may consider that the continuous PSFCH LBT failure occurs once, and the terminal device starts or restarts the continuous PSFCH LBT failure detection timer, and increments the continuous PSFCH LBT failure detection counter by 1.

Optionally, in the present disclosure, in a case where the terminal device is in the network coverage range, the terminal device may obtain fourth configuration information sent by the network device, and determine a value of N according to the fourth configuration information. In a case where the terminal device is out of the network coverage range, the value of N may be obtained via pre-configuration.

Optionally, the fourth configuration information may be the dedicated RRC signaling or the SIB signaling, that is, the terminal device may obtain the value of N via the dedicated RRC signaling or the SIB signaling.

Optionally, the continuous PSFCH LBT failure detection counter corresponding to the resource block set may be reset to be 0, in a case where at least one of the continuous PSFCH LBT failure detection timer corresponding to the resource block set or the maximum value of the continuous PSFCH LBT failure detection is reconfigured, to improve accuracy of counting the number of LBT failures for the PSFCH on the resource block set.

In addition, in a case where the number of LBT failures on the plurality of channels such as the PSSCH, the PSCCH, and the PSFCH associated with the resource block set is counted, the number of LBT failures for the PSFCH may be counted in a mode of determining that the number of LBT failures for the PSFCH is 1 if the LBT failure occurs on N continuous PSFCHs associated with any HARQ-enabled PSSCH.

In the embodiment of the present disclosure, the number of consistent LBT failures that occur on the plurality of PSFCHs associated with each HARQ-enabled PSSCH may be determined, by performing, before sending the HARQ feedback, the LBT failure detection on the plurality of PSFCHs associated with each HARQ-enabled PSSCH received on the resource block set. The continuous PSFCH LBT failure detection timer corresponding to the resource block set is started or restarted and the continuous PSFCH LBT failure detection counter corresponding to the resource block set is incremented by 1, in a case where the LBT failure occurs on N continuous PSFCHs associated with any HARQ-enabled PSSCH. Thus, the number of LBT failures for the PSFCH may be counted according to the granularity of the resource block set.

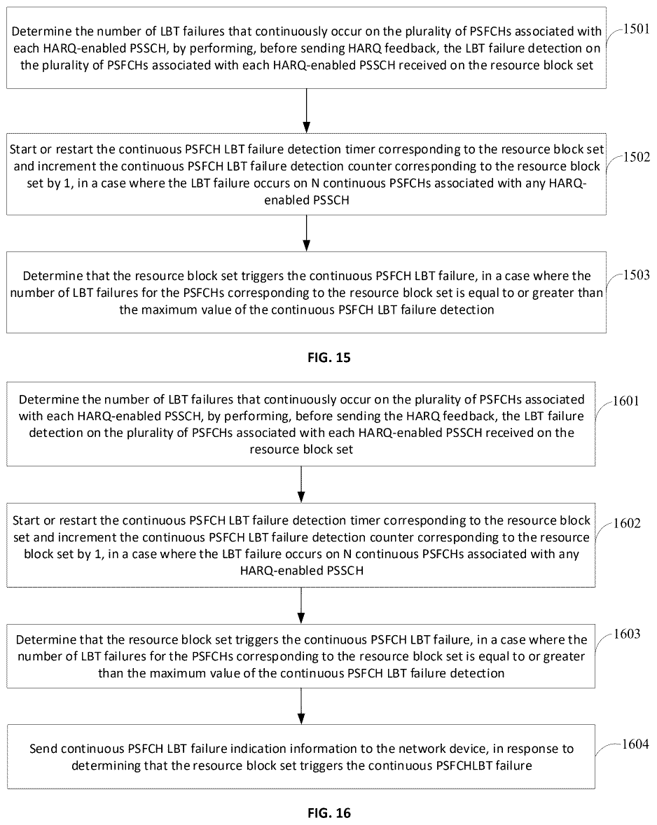

Please refer to FIG. 15, FIG. 15 is a schematic flowchart of another method for counting the number of LBT failures provided in an embodiment of the present disclosure, and the method is performed by the terminal device. As shown in FIG. 15, the method may include, but is not limited to the following steps.

Step 1501, the number of LBT failures that continuously occur on the plurality of PSFCHs associated with each HARQ-enabled PSSCH is determined, by performing, before the sending HARQ feedback, the LBT failure detection on the plurality of PSFCHs associated with each HARQ-enabled PSSCH received on the resource block set.

Step 1502, the continuous PSFCH LBT failure detection timer corresponding to the resource block set is started or restarted and the continuous PSFCH LBT failure detection counter corresponding to the resource block set is incremented by 1, in a case where the LBT failure occurs on N continuous PSFCHs associated with any HARQ-enabled PSSCH.

In the present disclosure, step 1501 and step 1502 may be implemented in any manner of the embodiments in the present disclosure respectively, which is not limited in the embodiments of the present disclosure and is not repeated.

Step 1503, it is determined that the resource block set triggers the continuous PSFCH LBT failure, in a case where the number of LBT failures for the PSFCHs corresponding to the resource block set is equal to or greater than the maximum value of the continuous PSFCH LBT failure detection.

In the present disclosure, it may be determined that the resource block set triggers the continuous PSFCH LBT failure, in a case where the number of LBT failures for the PSFCHs corresponding to the resource block set is greater than or equal to the maximum value of the continuous PSFCH LBT failure detection. The maximum value of the continuous PSFCH LBT failure detection may be pre-configured or configured by the network device, which is not limited in the present disclosure.

Optionally, the terminal device may obtain third configuration information sent by the network device, and determine the maximum value of the continuous PSFCH LBT failure detection according to the third configuration information.

In the present disclosure, for an explanation and description of the third configuration information, reference may be made to the above embodiments, which is not repeated here.

Optionally, the maximum value of the continuous PSFCH LBT failure detection used by the terminal device to determine whether the resource block set triggers the continuous PSFCH LBT failure may be the maximum value of the continuous PSFCH LBT failure detection corresponding to the resource block set in the third configuration information, or the maximum value of the continuous PSFCH LBT failure detection corresponding to the BWP, or the maximum value of the continuous PSFCH LBT failure detection corresponding to the cell to which the terminal device belongs. That is to say, the maximum value of the continuous PSFCH LBT failure detection may be configured according to the granularity of the resource block set, or the granularity of the BWP, or the granularity of the cell.

In the embodiment of the present disclosure, the number of LBT failures for the PSFCH on the resource block set may be counted by using the continuous PSFCH LBT failure detection timer corresponding to the resource block set, and it is determined that the resource block set triggers continuous PSFCH LBT failure in a case where the number of LBT failures for the PSFCHs corresponding to the resource block set is equal to or greater than the maximum value of the continuous PSFCH LBT failure detection. Thus, it is possible to count the number of LBT failures for the PSFCH according to the granularity of the resource block set, and determine whether the resource block set triggers the continuous PSFCH LBT failure according to the number of LBT failures for the PSFCH on the resource block set and the maximum value of the continuous PSFCH LBT failure detection.

Please refer to FIG. 16, FIG. 16 is a schematic flowchart of another method for counting the number of LBT failures provided in an embodiment of the present disclosure, and the method is performed by the terminal device. As shown in FIG. 16, the method may include, but is not limited to the following steps.

Step 1601, the number of LBT failures that continuously occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the resource block set.

Step 1602, the continuous PSFCH LBT failure detection timer corresponding to the resource block set is started or restarted, and the continuous PSFCH LBT failure detection counter corresponding to the resource block set is incremented by 1, in a case where the LBT failure occurs on N continuous PSFCHs associated with any HARQ-enabled PSSCH.

Step 1603, it is determined that the resource block set triggers the continuous PSFCH LBT failure, in a case where the number of LBT failures for the PSFCHs corresponding to the resource block set is equal to or greater than the maximum value of the continuous PSFCH LBT failure detection.

In the present disclosure, step 1601 to step 1603 may be implemented in any manner of the embodiments in the present disclosure respectively, which is not limited in the embodiments of the present disclosure and is not repeated.

Step 1604, continuous PSFCH LBT failure indication information is sent to the network device, in response to determining that the resource block set triggers the continuous PSFCH LBT failure.

In the present disclosure, the terminal device may send the continuous PSFCH LBT failure indication information to the network device in response to determining that the resource block set triggers the continuous PSFCH LBT failure, to notify the network device that the continuous PSFCH LBT failure occurs on the resource block set.

The continuous PSFCH LBT failure indication information may include indication information of the resource block set, such as identifier of the resource block set. Thus, the network device may determine that the continuous PSFCH LBT failure occurs on the resource block set according to the continuous PSFCH LBT failure indication information.

Optionally, in the present disclosure, the continuous PSFCH LBT failure indication information may be the MAC CE or the RRC signaling, etc., which is not limited in the present disclosure.

Optionally, in sidelink communication, allocation modes for the sending resource may include the mode of network dynamic scheduling, the mode that the terminal device autonomously selects from a resource block set broadcasted on the network, and so on.

Optionally, in a case where the terminal device is the terminal device with the resource allocation mode of network dynamic scheduling, or the terminal device with the mode of autonomously selecting from the resource block set in the RRC connection state. The continuous PSFCH LBT failure indication information may be sent to the network device in response to determining that the resource block set triggers the continuous PSFCH LBT failure. It is to be noted that in the present disclosure, whether the resource block set triggers the continuous PSFCH LBT failure may be determined using the manner in the above step 1601 to step 1603, or other manners, which is not limited in the present disclosure.

In the embodiment of the present disclosure, the number of LBT failures for the PSFCH may be counted according to the granularity of the resource block set. Whether the resource block set triggers the continuous PSFCH LBT failure may be determined according to the number of LBT failures for the PSFCH on the resource block set and the maximum value of the continuous PSFCH LBT failure detection. The continuous PSFCH LBT failure indication information may be sent to the network device in response to determining that the resource block set triggers the continuous PSFCH LBT failure and to notify the network device that the continuous PSFCH LBT failure occurs on the resource block set.

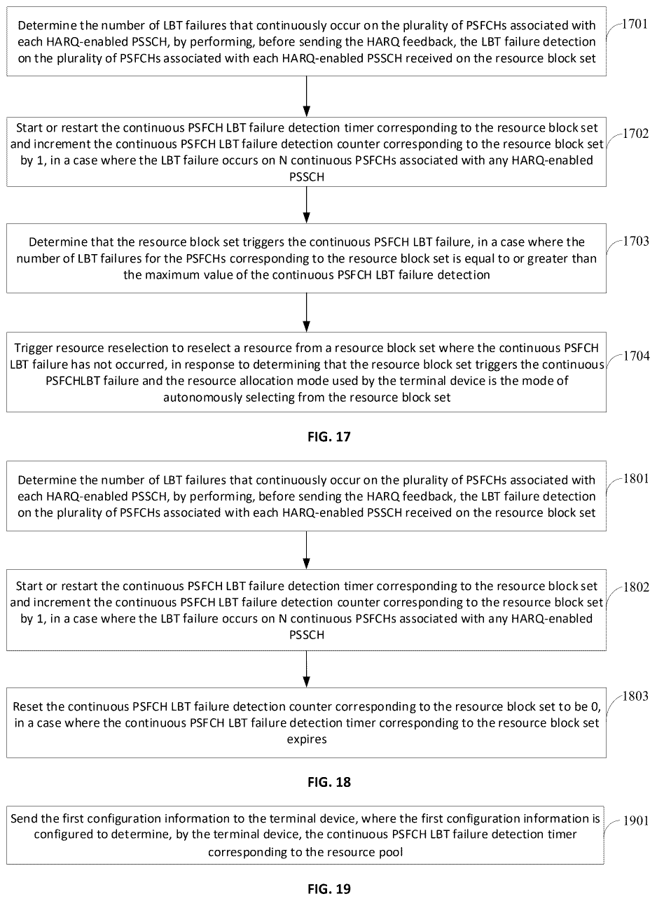

Please refer to FIG. 17, FIG. 17 is a schematic flowchart of another method for counting the number of LBT failures provided in an embodiment of the present disclosure, and the method is performed by the terminal device. As shown in FIG. 17, the method may include, but is not limited to the following steps.

Step 1701, the number of LBT failures that continuously occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the resource block set.

Step 1702, the continuous PSFCH LBT failure detection timer corresponding to the resource block set is started or restarted, and the continuous PSFCH LBT failure detection counter corresponding to the resource block set is incremented by 1, in a case where the LBT failure occurs on N continuous PSFCHs associated with any HARQ-enabled PSSCH.

Step 1703, it is determined that the resource block set triggers the continuous PSFCH LBT failure, in a case where the number of LBT failures for the PSFCHs corresponding to the resource block set is equal to or greater than the maximum value of the continuous PSFCH LBT failure detection.

In the present disclosure, step 1701 to step 1703 may be implemented in any manner of the embodiments in the present disclosure respectively, which is not limited in the embodiments of the present disclosure and is not repeated.

Step 1704, resource reselection is triggered to reselect a resource from the resource block set where the continuous PSFCH LBT failure has not occurred, in response to determining that the resource block set triggers the continuous PSFCH LBT failure and the resource allocation mode used by the terminal device is the mode of autonomously selecting from the resource block set.

In the present disclosure, in a case where the terminal device determines that the resource block set triggers the continuous PSFCH LBT failure and the resource allocation mode used by the terminal device is the mode of autonomously selecting from the resource block set, the terminal device may trigger the resource reselection to reselect the resource from the resource block set where the continuous PSFCH LBT failure has not occurred, to perform the HARQ feedback using the reselected resource.

It is to be noted that in the present disclosure, whether the resource block set triggers the continuous PSFCH LBT failure may be determined using the manner in the above step 1701 to step 1703, or other manners, which is not limited in the present disclosure.

In the embodiment of the present disclosure, the number of LBT failures for the PSFCH may be counted according to the granularity of the resource block set. Whether the resource block set triggers the continuous PSFCH LBT failure may be determined according to the number of LBT failures for the PSFCH on the resource block set and the maximum value of the continuous PSFCH LBT failure detection. The resource reselection may be triggered to reselect the resource from the resource block set where the continuous PSFCH LBT failure has not occurred, in response to determining that the resource block set triggers the continuous PSFCH LBT failure and the resource allocation mode used by the terminal device is the mode of autonomously selecting from the resource block set, to perform the HARQ feedback using the reselected resource. Thus, a transmission success rate of the HARQ feedback is increased.

Please refer to FIG. 18, FIG. 18 is a schematic flowchart of another method for counting the number of LBT failures provided in an embodiment of the present disclosure, and the method is performed by the terminal device. As shown in FIG. 18, the method may include, but is not limited to the following steps.

Step 1801, the number of LBT failures that continuously occur on the plurality of PSFCHs associated with each HARQ-enabled PSSCH is determined, by performing, before sending the HARQ feedback, the LBT failure detection on the plurality of PSFCHs associated with each HARQ-enabled PSSCH received on the resource block set.

Step 1802, the continuous PSFCH LBT failure detection timer corresponding to the resource block set is started or restarted and the continuous PSFCH LBT failure detection counter corresponding to the resource block set is incremented by 1, in a case where the LBT failure occurs on N continuous PSFCHs associated with any HARQ-enabled PSSCH.

In the present disclosure, step 1801 to step 1802 may be implemented in any manner of the embodiments in the present disclosure respectively, which is not limited in the embodiments of the present disclosure and is not repeated.

Step 1803, the continuous PSFCH LBT failure detection counter corresponding to the resource block set is reset to be 0, in a case where the continuous PSFCH LBT failure detection timer corresponding to the resource block set expires.

In the present disclosure, the duration of the continuous PSFCH LBT failure detection timer corresponding to the resource block set may be set by the network device or pre-configured, which is not limited to the present disclosure.

In the present disclosure, the continuous PSFCH LBT failure detection counter corresponding to the resource block set may be reset to be 0, in a case where the continuous PSFCH LBT failure detection timer corresponding to the resource block set expires, to recount the number of LBT failures for the PSFCH on the resource block set next time when the resource block set meets a counting condition of the number of LBT failures for the PSFCH.

In the embodiment of the present disclosure, the number of LBT failures for the PSFCH may be counted according to the granularity of the resource block set. The continuous PSFCH LBT failure detection counter corresponding to the resource block set may be reset to be 0, in a case where the continuous PSFCH LBT failure detection timer corresponding to the resource block set expires, to recount the number of LBT failures for the PSFCH on the resource block set next time when the resource block set meets the counting condition of the number of LBT failures for the PSFCH. Thus, accuracy of the number of LBT failures for the PSFCH on the resource block set is improved.

Please refer to FIG. 19, FIG. 19 is a schematic flowchart of another method for counting the number of LBT failures provided in an embodiment of the present disclosure, and the method is performed by the network device. As shown in FIG. 19, the method may include, but is not limited to the following steps.

Step 1901, the first configuration information is sent to the terminal device, where the first configuration information is configured to determine, by the terminal device, the continuous PSFCH LBT failure detection timer corresponding to the resource pool.

In the present disclosure, the network device may send the first configuration information to the terminal device to configure at least one of: the continuous PSFCH LBT failure detection timer configured to count the number of LBT failures for the PSFCH on the resource pool; or the maximum value of the continuous PSFCH LBT failure detection configured to determine whether the resource pool triggers the continuous PSFCH LBT failure.

Optionally, the first configuration information may be the dedicated RRC signaling or the SIB signaling, that is, the network device may configure at least one of the continuous PSFCH LBT failure detection timer or the maximum value of the continuous PSFCH LBT failure detection to the terminal device via the dedicated RRC signaling or the SIB signaling.

Optionally, the first configuration information may include any one of: at least one of the continuous PSFCH LBT failure detection timer or the maximum value of the continuous PSFCH LBT failure detection corresponding to the resource pool; at least one of the continuous PSFCH LBT failure detection timer or the maximum value of the continuous PSFCH LBT failure detection corresponding to the BWP to which the resource pool belongs; or the continuous PSFCH LBT failure detection timer or the maximum value of the continuous PSFCH LBT failure detection corresponding to the cell to which the terminal device belongs. That is to say, at least one of the continuous PSFCH LBT failure detection timer or the maximum value of the continuous PSFCH LBT failure detection may be configured according to the granularity of the resource pool, or the granularity of the BWP, or the granularity of the cell.

In the embodiment of the present disclosure, the network device may send the first configuration information to the terminal device. The network device may configure the continuous PSFCH LBT failure detection timer for the terminal device, which is configured to count the number of LBT failures for the PSFCH on the resource pool, via the first configuration information. Thus, the terminal device may count the number of LBT failures for the PSFCH on the resource pool according to the first configuration information.

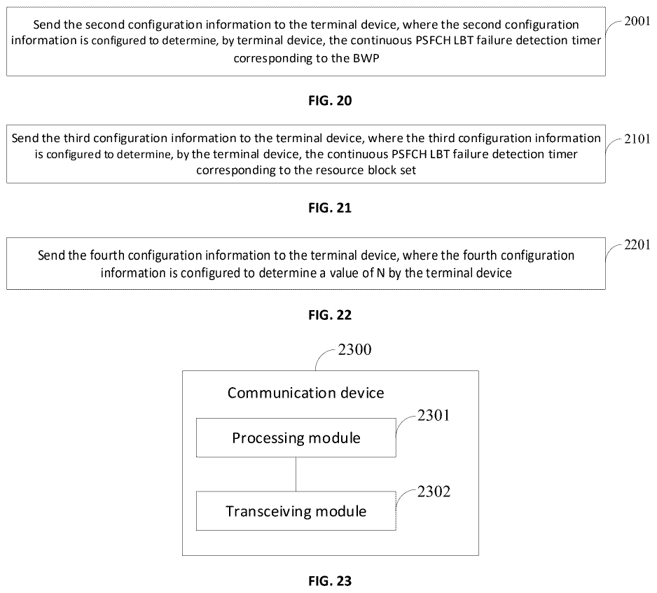

Please refer to FIG. 20, FIG. 20 is a schematic flowchart of another method for counting the number of LBT failures provided in an embodiment of the present disclosure, and the method is performed by the network device. As shown in FIG. 20, the method may include, but is not limited to the following steps.

Step 2001, the second configuration information is sent to the terminal device, where the second configuration information is configured to determine, by the terminal device, the continuous PSFCH LBT failure detection timer corresponding to the BWP.

In the present disclosure, the network device may send the second configuration information to the terminal device to configure at least one of: the continuous PSFCH LBT failure detection timer configured to count the number of LBT failures for the PSFCH on the BWP; or the maximum value of the continuous PSFCH LBT failure detection configured to determine whether the BWP triggers the continuous PSFCH LBT failure.

Optionally, the second configuration information may be the dedicated RRC signaling or the SIB signaling. That is, the network device may configure at least one of: the continuous PSFCH LBT failure detection timer or the maximum value of the continuous PSFCH LBT failure detection for the terminal device via the dedicated RRC signaling or the SIB signaling.

Optionally, the second configuration information may include any one of: at least one of the continuous PSFCH LBT failure detection timer or the maximum value of the continuous PSFCH LBT failure detection corresponding to the BWP; or at least one of the continuous PSFCH LBT failure detection timer or the maximum value of the continuous PSFCH LBT failure detection corresponding to the cell to which the terminal device belongs. That is to say, at least one of the continuous PSFCH LBT failure detection timer or the maximum value of the continuous PSFCH LBT failure detection may be configured according to the granularity of the BWP, or the granularity of the cell.

In the embodiment of the present disclosure, the network device may send the second configuration information to the terminal device. The network device may configure the continuous PSFCH LBT failure detection timer for the terminal device, which is configured to count the number of LBT failures for the PSFCH on the BWP via the second configuration information. Thus, the terminal device may count the number of LBT failures for the PSFCH on the BWP according to the second configuration information.

Please refer to FIG. 21, FIG. 21 is a schematic flowchart of another method for counting the number of LBT failures provided in an embodiment of the present disclosure, and the method is performed by the network device. As shown in FIG. 21, the method may include, but is not limited to the following steps.

Step 2101, the third configuration information is sent to the terminal device, where the third configuration information is configured to determine, by the terminal device, the continuous PSFCH LBT failure detection timer corresponding to the resource block set.

In the present disclosure, the network device may send the third configuration information to the terminal device to configure at least one of: the continuous PSFCH LBT failure detection timer configured to count the number of LBT failures for the PSFCH on the resource block set; or the maximum value of the continuous PSFCH LBT failure detection configured to determine whether the resource block set triggers the continuous PSFCH LBT failure.

Optionally, the third configuration information may be the dedicated RRC signaling or the SIB signaling. That is, the network device may configure at least one of: the continuous PSFCH LBT failure detection timer or the maximum value of the continuous PSFCH LBT failure detection for the terminal device via the dedicated RRC signaling or the SIB signaling.

Optionally, the third configuration information may include any one of: at least one of the continuous PSFCH LBT failure detection timer or the maximum value of the continuous PSFCH LBT failure detection corresponding to the resource block set; at least one of the continuous PSFCH LBT failure detection timer or the maximum value of the continuous PSFCH LBT failure detection corresponding to the BWP to which the resource block set belongs; or at least one of the continuous PSFCH LBT failure detection timer or the maximum value of the continuous PSFCH LBT failure detection corresponding to the cell to which the terminal device belongs. That is to say, at least one of the continuous PSFCH LBT failure detection timer or the maximum value of the continuous PSFCH LBT failure detection may be configured according to the granularity of the resource block set, or the granularity of the BWP, or the granularity of the cell.

In the embodiment of the present disclosure, the network device may send the third configuration information to the terminal device. The network device may configure, for the terminal device, the continuous PSFCH LBT failure detection timer, which is configured to count the number of LBT failures for the PSFCH on the resource block set, via the third configuration information. Thus, the terminal device may count the number of LBT failures for the PSFCH on the resource block set according to the third configuration information.

Please refer to FIG. 22, FIG. 22 is a schematic flowchart of another method for counting the number of LBT failures provided in an embodiment of the present disclosure, and the method is performed by the network device. As shown in FIG. 22, the method may include, but is not limited to the following steps.

Step 2201, the fourth configuration information is sent to the terminal device, where the fourth configuration information is configured to determine a value of N by the terminal device.

In the present disclosure, N is the number of PSFCHs, determined by the terminal device, on which the LBT failure continuously occurs and which are associated with the HARQ-enabled PSSCH. N is a positive integer less than or equal to M, and M is the number of PSFCHs associated with the HARQ-enabled PSSCH.

In the present disclosure, the network device may send the fourth configuration information to the terminal device to configure the value of N for the terminal device.

Optionally, the fourth configuration information may be the dedicated RRC signaling or the SIB signaling, that is, the network device may configure the value of N for the terminal device via the dedicated RRC signaling or the SIB signaling.

In the embodiment of the present disclosure, the network device may send the fourth configuration information to the terminal device to configure the value of N for the terminal device. Thus, the terminal device may count the number of LBT failures for the PSFCH according to the number of PSFCHs on which the LBT failure continuously occurs and which are associated with the HARQ-enabled PSSCH configured by the network device.

In order to facilitate the understanding of the method for counting the number of LBT failures in the present disclosure, further explanation will be provided below in conjunction with the following embodiments.
I. In a case where N LBT failures continuously occur on the PSFCH resource associated with one PSSCH, UE determines that the LBT failure occurs once.

In a case where one PSSCH may be associated with the plurality of PSFCH resources, for HARQ feedback-enabled sidelink MACPDU, the UE sends the HARQ feedback on all PSFCH resources associated with the PSSCH. In a case where the LBT failure occurs (receiving LBT failure indication from the PHY) on occasions of N continuous PSFCH resources associated with the PSSCH, resulting in HARQ feedback transmission failure, the UE determines that LBT failure occurs once, and merely counts in a case where the number of LBT failures is counted. A maximum value of N is the number of PSFCH resources that may be associated with one PSSCH, and a minimum value of N is 1. In a case where the value of N is 1, the LBT failure occurs (receiving the LBT failure indication from the PHY) for the UE on an occasion of any PSFCH resource associated with the PSSCH, resulting in HARQ transmission failure, and the UE determines that LBT occurs once, and counts once in a case where the number of LBT failures is counted. In a case where the value of N is the number of PSFCH resources that may be associated with the PSSCH, and in a case where the LBT failure occurs (receiving the LBT failure indication from the PHY) on occasions of all PSFCH resources associated with the PSSCH, resulting in HARQ transmission failure, the UE determines that LBT failure occurs once, and merely counts 1 in a case where the number of LBT failures is counted.

The UE may obtain the value of N via network side configuration or pre-configuration, or the value of N may be selected by the terminal device according to the condition.

The UE in the network coverage range may obtain the value of N via the dedicated RRC signaling or the SIB signaling, while the UE out of the network coverage range may obtain the value of N via pre-configuration.
II. A continuous PSFCH LBT failure detection timer, a continuous PSFCH LBT failure detection counter, and a maximum value of the continuous PSFCH LBT failure detection are configured.

The timer or the maximum value may be configured for each BWP or each cell, or each resource pool, or each resource block set. The timer or the counter is maintained for each BWP or each cell, or each resource pool, or each resource block set. The timer or the maximum value may be configured by the network device or pre-configured. The UE in the network coverage range may obtain the timer or the maximum value via the dedicated RRC signaling or the SIB signaling, while the UE out of the network coverage range may obtain the timer or the maximum value via pre-configuration.
III. The UE may maintain one continuous PSFCH LBT failure detection counter for each BWP, each resource pool or each resource block set. UE detects whether the LBT failure occurs on the plurality of PSFCH resources associated with each PSSCH received on each BWP, each resource pool or each resource block set. In a case where the LBT failure occurs on N continuous PSFCH resources associated with any PSSCH, the UE starts or restarts the continuous PSFCH LBT failure detection timer, and the UE increments the continuous PSFCH LBT failure detection counter by 1.

The maximum value of N is the number of PSFCH resources that may be associated with one PSSCH, and the minimum value of N is 1. Please refer to the above embodiments for specific details. Taking the BWP as an example, for each HARQ-enabled PSSCH received on this BWP, the UE, as a receiving UE, sends the HARQ feedback on the PSFCH resource associated with the PSSCH without distinguishing between unicast, multicast, or broadcast. In a case where the LBT failure occurs on N continuous PSFCH resources, the UE considers that the PSFCH LBT failure occurs once, and the UE starts or restarts the continuous PSFCH LBT failure detection timer, and increments the continuous PSFCH LBT failure detection counter by 1.
IV. The UE triggers the continuous PSFCH LBT failure, in a case where the continuous PSFCH LBT failure detection counter reaches or exceeds a maximum value.
V. The UE resets the continuous PSFCH LBT failure detection counter to be 0, in a case where the continuous PSFCH LBT failure detection timer expires.
VI. The UE resets the continuous PSFCH LBT failure detection counter to be 0, in a case where at least one of the continuous PSFCH LBT failure detection timer or the maximum value of the continuous PSFCH LBT failure detection is reconfigured.
VII. The UE triggers the continuous PSFCH LBT failure, and reports the same to the network device via a continuous PSFCH LBT failure report.

The UE triggers the continuous PSFCH LBT failure, and mode1 UE or mode2 UE in an RRC connected state reports the same to a network side via the PSFCH LBT failure report. The PSFCH LBT failure report may be the MAC CE or the RRC signaling, carrying an indication of a BWP, a RP or a RB set where the continuous PSFCH LBT failure occurs.
VIII. The UE triggers the resource reselection to reselect a resource pool where the continuous PSFCH LBT failure has not occurred, in a case where the UE determines that the resource pool triggers the continuous PSFCH LBT failure.

The mode2 UE triggers the resource reselection to reselect the resource from the resource pool where the continuous PSFCH LBT failure has not occurred, in a case where the UE determines that the resource pool triggers the continuous PSFCH LBT failure.

It is to be noted that in the present disclosure, mode1UE, for example, refers to UE whose resource allocation mode is the mode of network dynamic scheduling. Mode2 UE, for example, refers to UE whose resource allocation mode is the mode of autonomously selecting from the resource pool.

Please refer to FIG. 23, FIG. 23 is a schematic structural diagram of a communication device provided in an embodiment of the present disclosure. The communication device 2300 shown in FIG. 23 may include a processing module 2301 and a transceiving module 2302. The transceiving module 2302 may include at least one of a sending module or a receiving module. The sending module is configured to implement a sending function, the receiving module is configured to implement a receiving function, and the transceiving module 2302 may implement at least one of the sending function or the receiving function.

It may be understood that the communication device 2300 may be a terminal device, or a device in the terminal device, or a device that can be matched with the terminal device for use.

The communication device 2300 is on a terminal device side, where:
the processing module 2301 is configured to determine the number of LBT failures that continuously occur on the PSFCH associated with the HARQ-enabled PSSCH; and
count the number of LBT failures for the PSFCH according to the number of LBT failures that continuously occur on the PSFCH associated with the HARQ-enabled PSSCH.

Optionally, the processing module 2301 is configured to determine that the LBT failure for the PSFCH occurs once, in a case where the LBT failure occurs on N continuous PSFCHs associated with the HARQ-enabled PSSCH; where, N is the positive integer less than or equal to M, and M is the number of the PSFCHs associated with the HARQ-enabled PSSCH.

Optionally, the processing module 2301 is configured to determine the number of consistent LBT failures that occur on the plurality of PSFCHs associated with each HARQ-enabled PSSCH, by performing, before sending the HARQ feedback, the LBT failure detection on the plurality of PSFCHs associated with each HARQ-enabled PSSCH received on the resource pool.

Optionally, the processing module 2301 is configured to:
start or restart the continuous PSFCH LBT failure detection timer corresponding to the resource pool and increment a continuous PSFCH LBT failure detection counter corresponding to the resource pool by 1, in a case where the LBT failure occurs on N continuous PSFCHs associated with any HARQ-enabled PSSCH; where N is the positive integer less than or equal to M, and M is the number of the PSFCHs associated with the HARQ-enabled PSSCH.

Optionally, the processing module 2301 is further configured to:
determine that the resource pool triggers the continuous PSFCH LBT failure, in a case where the number of LBT failures for the PSFCHs corresponding to the resource pool is equal to or greater than the maximum value of the continuous PSFCH LBT failure detection.

Optionally, the communication device 2300 may further include:
the transceiving module 2302, configured to send the continuous PSFCH LBT failure indication information to the network device, in response to determining that the resource pool triggers the continuous PSFCH LBT failure; where the continuous PSFCH LBT failure indication information includes indication information of the resource pool.

Optionally, the processing module 2301 is further configured to:
trigger the resource reselection to reselect the resource from the resource pool where the continuous PSFCH LBT failure has not occurred, in response to determining that the resource pool triggers the continuous PSFCH LBT failure and the resource allocation mode used by the terminal device is the mode of autonomously selecting from the resource pool.

Optionally, the processing module 2301 is further configured to:
reset the continuous PSFCH LBT failure detection counter corresponding to the resource pool to be 0, in a case where the continuous PSFCH LBT failure detection timer corresponding to the resource pool expires.

Optionally, the processing module 2301 is further configured to:
reset the continuous PSFCH LBT failure detection counter corresponding to the resource pool to be 0, in a case where at least one of the continuous PSFCH LBT failure detection timer corresponding to the resource pool or the maximum value of the continuous PSFCH LBT failure detection is reconfigured.

Optionally, the communication device 2300 may further include:
the transceiving module 2302, configured to receive first configuration information sent by the network device; and the processing module 2301, further configured to determine at least one of the continuous PSFCH LBT failure detection timer or the maximum value of the continuous PSFCH LBT failure detection, according to the first configuration information.

The first configuration information includes any one of:
at least one of the continuous PSFCH LBT failure detection timer or the maximum value of the continuous PSFCH LBT failure detection corresponding to the resource pool;
at least one of the continuous PSFCH LBT failure detection timer or the maximum value of the continuous PSFCH LBT failure detection corresponding to the bandwidth part (BWP) to which the resource pool belongs; or
at least one of the continuous PSFCH LBT failure detection timer or the maximum value of the continuous PSFCH LBT failure detection corresponding to the cell to which the terminal device belongs.

Optionally, the processing module 2301 is configured to:
determine the number of LBT failures that continuously occur on the plurality of PSFCHs associated with each HARQ-enabled PSSCH, by performing, before sending the HARQ feedback, the LBT failure detection on the plurality of PSFCHs associated with each HARQ-enabled PSSCH received on the BWP.

Optionally, the processing module 2301 is configured to:
start or restart the continuous PSFCH LBT failure detection timer corresponding to the BWP and increment the continuous PSFCH LBT failure detection counter corresponding to the BWP by 1, in a case where the LBT failure occurs on N continuous PSFCHs associated with any HARQ-enabled PSSCH; where N is a positive integer less than or equal to M, and M is the number of the PSFCHs associated with the HARQ-enabled PSSCH.

Optionally, the processing module 2301 is configured to:
determine that the BWP triggers the continuous PSFCH LBT failure, in a case where the number of LBT failures for the PSFCHs corresponding to the BWP is equal to or greater than the maximum value of the continuous PSFCH LBT failure detection.

Optionally, the communication device 2300 further includes:
the transceiving module 2302, configured to send the continuous PSFCH LBT failure indication information to the network device, in response to determining that the BWP triggers the continuous PSFCH LBT failure; where the continuous PSFCH LBT failure indication information includes indication information of the BWP.

Optionally, the processing module 2301 is configured to:
determine to trigger the sidelink RLF in response to determining that the BWP triggers the continuous PSFCH LBT failure.

Optionally, the processing module 2301 is configured to:
reset the continuous PSFCH LBT failure detection counter corresponding to the BWP to be 0, in a case where the continuous PSFCH LBT failure detection timer corresponding to the BWP expires.

Optionally, the processing module 2301 is configured to:
reset the continuous PSFCH LBT failure detection counter corresponding to the BWP to be 0, in a case where at least one of the continuous PSFCH LBT failure detection timer corresponding to the BWP or the maximum value of the continuous PSFCH LBT failure detection is reconfigured.

Optionally, the communication device 2300 further includes:
the transceiving module 2302, configured to receive the second configuration information sent by the network device; and
the processing module 2301, further configured to determine at least one of the continuous PSFCH LBT failure detection timer or the maximum value of the continuous PSFCH LBT failure detection, according to the second configuration information.

Optionally, the second configuration information includes any one of:
at least one of the continuous PSFCH LBT failure detection timer or the maximum value of continuous PSFCH LBT failure detection corresponding to the BWP; or
at least one of the continuous PSFCH LBT failure detection timer or the maximum value of the continuous PSFCH LBT failure detection corresponding to the cell to which the terminal device belongs.

Optionally, the processing module 2301 is configured to determine the number of LBT failures that continuously occur on the plurality of PSFCHs associated with each HARQ-enabled PSSCH, by performing, before sending the HARQ feedback, the LBT failure detection on the plurality of PSFCHs associated with each HARQ-enabled PSSCH received on the resource block set.

Optionally, the processing module 2301 is configured to:
start or restart the continuous PSFCH LBT failure detection timer corresponding to the resource block set and increment the continuous PSFCH LBT failure detection counter corresponding to the resource block set by 1, in a case where the LBT failure occurs on N continuous PSFCHs associated with any HARQ-enabled PSSCH; where N is a positive integer less than or equal to M, and M is the number of the PSFCHs associated with the HARQ-enabled PSSCH.

Optionally, the processing module 2301 is configured to determine that the resource block set triggers the continuous PSFCH LBT failure, in a case where the number of LBT failures for the PSFCHs corresponding to the resource block set is equal to or greater than the maximum value of the continuous PSFCH LBT failure detection.

Optionally, the communication device 2300 further includes:
the transceiving module 2302, configured to send continuous PSFCH LBT failure indication information to the network device, in response to determining that the resource block set triggers the continuous PSFCH LBT failure; where the continuous PSFCH LBT failure indication information includes indication information of the resource block set.

Optionally, the processing module 2301 is further configured to:
trigger the resource reselection to reselect the resource from the resource block set where the continuous PSFCH LBT failure has not occurred, in response to determining that the resource block set triggers the continuous PSFCH LBT failure and the resource allocation mode used by the terminal device is the mode of autonomously selecting from the resource block set.

Optionally, the processing module 2301 is further configured to:
reset the continuous PSFCH LBT failure detection counter corresponding to the resource block set to be 0, in a case where the continuous PSFCH LBT failure detection timer corresponding to the resource block set expires.

Optionally, the processing module 2301 is further configured to:
reset the continuous PSFCH LBT failure detection counter corresponding to the resource block set to be 0, in a case where at least one of the continuous PSFCH LBT failure detection timer corresponding to the resource block set or the maximum value of the continuous PSFCH LBT failure detection is reconfigured.

Optionally, the communication device 2300 may further include:
the transceiving module 2302, configured to obtain fourth configuration information sent by the network device; and
the processing module 2301, further configured to determine the value of N according to the fourth configuration information.

In the present disclosure, by determining the number of LBT failures that continuously occur on the PSFCH associated with the HARQ-enabled PSSCH, and counting the number of LBT failures for the PSFCH according to the number of LBT failures that continuously occur on the PSFCH associated with the HARQ-enabled PSSCH, a problem of how the terminal device counts the number of LBT failures for the PSFCH in a case where the HARQ-enabled PSSCH is associated with the plurality of PSFCH resources can be solved, frequent triggering of sidelink consistent LBT failure may be avoided, and the communication quality of the link is improved.

It may be understood that the communication device 2300 may be a network device, or a device in the network device, or a device that can be used in conjunction with the network device.

The communication device 2300 is on a network device side, where:
the transceiving module 2302 is configured to send the first configuration information to the terminal device, where the first configuration information is configured to determine, by the terminal device, the continuous PSFCH LBT failure detection timer corresponding to the resource pool, and the continuous PSFCH LBT failure detection timer corresponding to the resource pool is configured to count the number of LBT failures for the PSFCH on the resource pool.

Optionally, the first configuration information includes any one of:
at least one of the continuous PSFCH LBT failure detection timer or the maximum value of the continuous PSFCH LBT failure detection corresponding to the resource pool;
at least one of the continuous PSFCH LBT failure detection timer or the maximum value of the continuous PSFCH LBT failure detection corresponding to the BWP to which the resource pool belongs; or
at least one of the continuous PSFCH LBT failure detection timer or the maximum value of the continuous PSFCH LBT failure detection corresponding to the cell to which the terminal device belongs.

Optionally, the transceiving module 2302 is further configured to:
send the second configuration information to the terminal device, where the second configuration information is configured to determine, by the terminal device, the continuous PSFCH LBT failure detection timer corresponding to the BWP, and the continuous PSFCH LBT failure detection timer corresponding to the BWP is configured to count the number of LBT failures for the PSFCH on the BWP.

Optionally, the second configuration information includes any one of:
at least one of the continuous PSFCH LBT failure detection timer or the maximum value of the continuous PSFCH LBT failure detection corresponding to the BWP; or
at least one of the continuous PSFCH LBT failure detection timer or the maximum value of the continuous PSFCH LBT failure detection corresponding to the cell to which the terminal device belongs.

Optionally, the transceiving module 2302 is further configured to:
send the third configuration information to the terminal device, where the third configuration information is configured to determine, by the terminal device, the continuous PSFCH LBT failure detection timer corresponding to the resource block set, and the continuous PSFCH LBT failure detection timer corresponding to the resource block set is configured to count the number of LBT failures for the PSFCH on the resource block set.

Optionally, the third configuration information includes any one of:
at least one of the continuous PSFCH LBT failure detection timer or the maximum value of continuous PSFCH LBT failure detection corresponding to the resource block set;
at least one of the continuous PSFCH LBT failure detection timer or the maximum value of the continuous PSFCH LBT failure detection corresponding to the BWP to which the resource block set belongs; or
at least one of the continuous PSFCH LBT failure detection timer or the maximum value of the continuous PSFCH LBT failure detection corresponding to the cell to which the terminal device belongs.

Optionally, the transceiving module 2302 is further configured to:
send the fourth configuration information to the terminal device, where the fourth configuration information is configured to determine the value of N by the terminal device, and N is the number of PSFCHs, determined by the terminal device, on which the LBT failure continuously occur and which are associated with the HARQ-enabled PSSCH.

In the present disclosure, the network device may send the first configuration information to the terminal device. The network device may configure the continuous PSFCH LBT failure detection timer for the terminal device, which is configured to count the number of LBT failures for the PSFCH on the resource pool, via the first configuration information. Thus, the terminal device may count the number of LBT failures for the PSFCH on the resource pool according to the first configuration information.

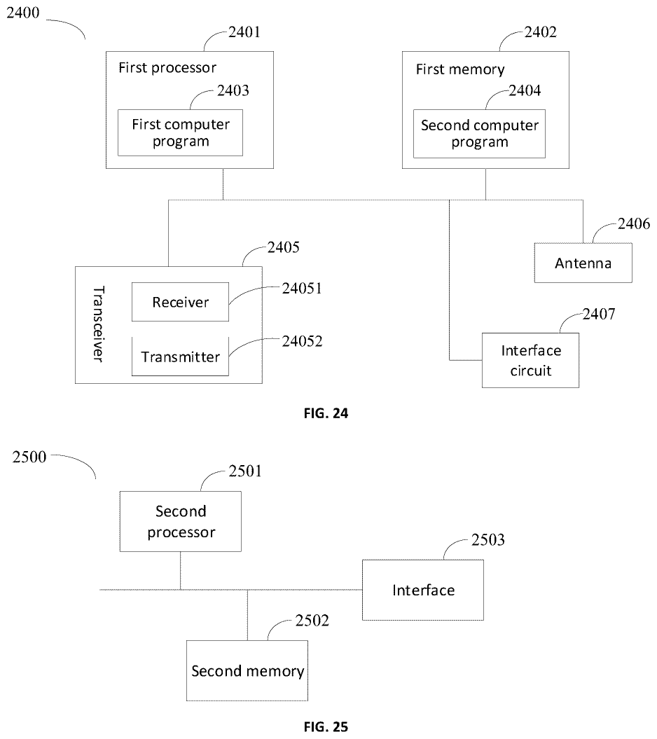

Please refer to FIG. 24, FIG. 24 is a schematic structural diagram of another communication device provided in an embodiment of the present disclosure. In FIG. 24, the communication device 2400 may be the network device, may also be the terminal device, may also be a chip, a system on the chip, or a processor that supports the network device to implement the methods above, and may further be a chip, a system on the chip, or a processor that supports the terminal device to implement the methods above. This device may be configured to perform the methods described in the above method embodiments, which may specifically refer to illustration in the above method embodiments.

The communication device 2400 may include one or more first processors 2401. The first processor 2401 may be a general-purpose processor or a dedicated processor. For example, it may be a baseband processor or a central processing unit. The baseband processor may be configured to process a communication protocol and communication data, while the central processing unit may be configured to control a communication device (such as the base station, a baseband chip, the terminal device, a terminal device chip, the DU or the CU), executing a computer program, and processing data from the computer program.

Optionally, the communication device 2400 may further include one or more first memories 2402 on which a second computer program 2404 can be stored, and the first processor 2401 executes the second computer program 2404 to cause the communication device 2400 to perform the methods described in the above method embodiments. Optionally, the first memory 2402 may further store data. The communication device 2400 and the first memory 2402 may be arranged separately or integrated together.

Optionally, the communication device 2400 may further include a transceiver 2405 and an antenna 2406. The transceiver 2405, which may be referred to as a transceiving unit, a transceiving machine, or a transceiving circuit, etc., is configured to achieve a transceiving function. The transceiver 2405 may include a receiver 24051 and a transmitter 24052, and the receiver 24051 may be referred to as a receiving machine or a receiving circuit, for achieving a reception function; and the transmitter 24052 may be referred to as a transmitting machine or a transmitting circuit, for achieving a transmitting function.

Optionally, the communication device 2400 may further include one or more interface circuits 2407. The interface circuit 2407 is configured to receive code instructions and transmit the code instructions to the first processor 2401. The first processor 2401 runs the code instructions to cause the communication device 2400 to perform the method described in the above method embodiments.

The communication device 2400 is a terminal device. The first processor 2401 is configured to perform step 201 and step 202 in FIG. 2; step 301 and step 302 in FIG. 3; step 401 and step 402 in FIG. 4; and step 501, step 502 in FIG. 5, etc.

The communication device 2400 is the network device. The transceiver 2405 is configured to perform step 604 in FIG. 6; step 1104 in FIG. 11; and step 1601 in FIG. 16.

In one implementation, the first processor 2401 may include a transceiver for implementing receiving and sending functions. For example, the transceiver may be a transceiving circuit, an interface, or an interface circuit. The transceiving circuit, interface, or interface circuit, which is configured to achieve the receiving and sending functions, may be separate or integrated together. The above transceiving circuit, interface, or interface circuit may be configured to read and write codes or data, or the above transceiving circuit, interface, or interface circuit may be configured to transmit or transfer the signal.

In one implementation, the first processor 2401 may store a first computer program 2403, and the first computer program 2403 runs on the first processor 2401, to cause the communication device 2400 to perform the methods described in the above method embodiments. The first computer program 2403 may be embedded in the first processor 2401, in which case the first processor 2401 may be implemented by hardware.

In an implementation, the communication device 2400 may include a circuit, and the circuit may achieve the functions of transmitting, receiving, or communicating in the aforementioned method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, and the like. The processor and transceiver may also be manufactured using various IC process technologies, such as a complementary metal oxide semiconductor (CMOS), an n-metal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device described in the above embodiments may be the network device or the terminal device, but the scope of the communication device described in the present disclosure is not limited to this. The structure of the communication device may be not limited by FIG. 24. The communication device may be an independent device or may be part of a larger device. For example, the communication device may be:
(1) an independent integrated circuit (IC), or a chip, or a system on a chip or a subsystem;
(2) a set with one or more ICs, optionally the IC set including a storage component for storing data and a computer program;
(3) an ASIC, such as a modem;
(4) a module that can be embedded in other devices;
(5) a receiving machine, a terminal device, an intelligent terminal device, a cellular phone, a wireless device, a handheld machine, a mobile unit, an on-board device, a network device, a cloud device, an artificial intelligence device, etc.; and
(6) others and so on.

For a case that the communication device may be a chip or a system on a chip, please refer to a schematic structural diagram of a chip shown in FIG. 25. The chip 2500 shown in FIG. 25 includes a second processor 2501 and an interface 2503. The number of the second processors 2501 may be one or more, and the number of the interfaces 2503 may be multiple.

For a case in which the chip is configured to implement a function of the terminal device in an embodiment of the present disclosure:

The interface 2503 is configured to perform step 604 in FIG. 6; step 1104 in FIG. 11; and step 1601 in FIG. 16, etc.

For a case in which the chip is configured to implement a function of the network device in an embodiment of the present disclosure:

The interface 2503 is configured to perform step 1901 in FIG. 19; step 2001 in FIG. 20; step 2101 in FIG. 21; and step 2201 in FIG. 22, etc.

Optionally, the chip 2500 further includes a second memory 2502, and the second memory 2502 is configured to store the needful computer program and data.

Those skilled in the art can further understand that the various illustrative logical blocks and steps listed in the embodiment of the present disclosure may be implemented via electronic hardware, computer software, or a combination of the two. Whether such functions are implemented via hardware or software depends on the specific application and design requirements of the overall system. Those skilled in the art can use various methods to achieve the described functions for each specific application, but such implementation needs not be understood as exceeding the scope of protection of the embodiment of the present disclosure.

As used herein, the term processor may refer to one processor that performs the defined functions or a plurality of processors that collectively perform defined functions, such that the execution of the individual defined functions may be divided amongst such processors.

The present disclosure further provides a non-transitory readable storage medium storing instructions, and the instructions, when executed by a computer, implement the function of any of the above method embodiments.

The present disclosure further provides a computer program product, and the computer program product, when executed by a computer, implements the function of any of the above method embodiments.

In the above embodiments, it can be fully or partially implemented via software, hardware, firmware, or any combination of them. When implemented using the software, it can be fully or partially implemented in a form of the computer program product. The computer program product includes one or more computer programs. When loading and executing the computer program on the computer, processes or functions described in the embodiment of the present disclosure are fully or partially generated. The computer may be a general-purpose computer, a dedicated computer, a computer network, or other programmable devices. The computer program may be stored in a non-transitory computer-readable storage medium or transmitted from one non-transitory computer-readable storage medium to another. For example, the computer program may be transmitted from a website, a computer, a server or a data center to another website, computer, server, or data center via a wired (such as a coaxial cable, an optical fiber, a digital subscriber line (DSL)) or wireless (such as infrared, wireless, and microwave) mode. The non-transitory computer-readable storage medium may be any available medium that the computer can access, or a data storage device such as a server or a data center that is integrated by one or more available media. The available medium may be a magnetic medium (such as a floppy disk, a hard drive, and a magnetic tape), an optical medium (such as a high-density digital video disc (DVD)), or a semiconductor medium (such as a solid state disk (SSD)), etc.

Those ordinarily skilled in the art can understand that the first, second, and other numerical numbers involved in the present disclosure are merely differentiation for the convenience of description, and are not intended to limit the scope of the embodiment of the present disclosure, but also indicate the sequential order.

At least one in the present disclosure can further be described as one or more, and a plurality of may be two, three, four, or more, which is not limited in the present disclosure. In the embodiment of the present disclosure, for a technical feature, the technical features described in the technical feature are distinguished by “first,” “second,” “third,” “A,” “B,” “C,” and “D”, and the technical features described by “first,” “second,” “third,” “A,” “B,” “C,” and “D” have no any sequential order or order of size.

The corresponding relationships shown in tables in the present disclosure may be configured or predefined. Values of information in each table are only examples and may be configured as other values, which is not limited in the present disclosure. When configuring the corresponding relationships between the information and various parameters, it does not need to configure all the corresponding relationships shown in each table. For example, in the tables in the present disclosure, the corresponding relationships shown in certain rows may not be configured. For another example, appropriate deformation and adjustments, such as splitting and merging, can be made based on the above tables. The names of parameters shown in titles of the above tables may also use other names that can be understood by the communication device, and the values or representations of the parameters may also be other values or representations understood by the communication device. When implementing the above tables, other data structures can also be used, such as an array, a queue, a container, a stack, a linear table, a pointer, a linked list, a tree, a graph, a structure, a class, a heap, a hashing table, or a hash table.

1. A method for counting a number of consistent listen before talk (LBT) failures, performed by a terminal device, comprising:
determining a number of LBT failures that continuously occur on a physical sidelink feedback channel (PSFCH) associated with a hybrid automatic repeat request (HARQ)-enabled physical sidelink shared channel (PSSCH); and
counting a number of LBT failures for the PSFCH according to the number of LBT failures that continuously occur on the PSFCH associated with the HARQ-enabled PSSCH.

2. The method according to claim 1, wherein counting the number of LBT failures for the PSFCH according to the number of LBT failures that continuously occur on the PSFCH associated with the HARQ-enabled PSSCH comprises:
determining that the LBT failure for the PSFCH occurs once, in a case where the LBT failure occurs on N continuous PSFCHs associated with the HARQ-enabled PSSCH;
wherein N is a positive integer less than or equal to M, and M is a number of PSFCHs associated with the HARQ-enabled PSSCH.

3. The method according to claim 1, wherein determining the number of LBT failures that continuously occur on the PSFCH associated with the HARQ-enabled PSSCH comprises:
determining a number of LBT failures that continuously occur on a plurality of PSFCHs associated with each HARQ-enabled PSSCH, by performing, before sending a HARQ feedback, a LBT failure detection on the plurality of PSFCHs associated with each HARQ-enabled PSSCH received on a resource pool; or
determining the number of LBT failures that continuously occur on the plurality of PSFCHs associated with each HARQ-enabled PSSCH, by performing, before sending the HARQ feedback, the LBT failure detection on the plurality of PSFCHs associated with each HARQ-enabled PSSCH received on a bandwidth part (BWP); or
determining the number of LBT failures that continuously occur on the plurality of PSFCHs associated with each HARQ-enabled PSSCH, by performing, before sending the HARQ feedback, the LBT failure detection on the plurality of PSFCHs associated with each HARQ-enabled PSSCH received on a resource block set.

4. The method according to claim 3, wherein counting the number of LBT failures for the PSFCH according to the number of LBT failures that continuously occur on the PSFCH associated with the HARQ-enabled PSSCH comprises:
starting or restarting a continuous PSFCH LBT failure detection timer corresponding to the resource pool and incrementing a continuous PSFCH LBT failure detection counter corresponding to the resource pool by 1, in a case where the LBT failure occurs on N continuous PSFCHs associated with any HARQ-enabled PSSCH; wherein N is a positive integer less than or equal to M, and M is a number of PSFCHs associated with the HARQ-enabled PSSCH.

5. The method according to claim 4, further comprising:
determining that the resource pool triggers a continuous PSFCH LBT failure, in a case where a number of LBT failures for the PSFCHs corresponding to the resource pool is equal to or greater than a maximum value of a continuous PSFCH LBT failure detection; or
resetting the continuous PSFCH LBT failure detection counter corresponding to the resource pool to be 0, in a case where the continuous PSFCH LBT failure detection timer corresponding to the resource pool expires; or
resetting the continuous PSFCH LBT failure detection counter corresponding to the resource pool to be 0, in a case where at least one of the continuous PSFCH LBT failure detection timer corresponding to the resource pool or the maximum value of the continuous PSFCH LBT failure detection is reconfigured.

6. The method according to claim 5, further comprising:
sending continuous PSFCH LBT failure indication information to a network device, in response to determining that the resource pool triggers the continuous PSFCH LBT failure; wherein the continuous PSFCH LBT failure indication information comprises indication information of the resource pool; or
triggering resource reselection to reselect a resource from a resource pool where the continuous PSFCH LBT failure has not occurred, in response to determining that the resource pool triggers the continuous PSFCH LBT failure and a resource allocation mode used by the terminal device is a mode of autonomously selecting from the resource pool.

7.-9. (canceled)

10. The method according to claim 5, the method further comprises:
receiving first configuration information sent by a network device; and
determining at least one of the continuous PSFCH LBT failure detection timer or the maximum value of the continuous PSFCH LBT failure detection, according to the first configuration information; or
the method further comprises:
receiving second configuration information sent by a network device; and
determining at least one of the continuous PSFCH LBT failure detection timer or the maximum value of the continuous PSFCH LBT failure detection, according to the second configuration information; or
the method further comprises:
receiving third configuration information sent by a network device; and
determining at least one of the continuous PSFCH LBT failure detection timer or the maximum value of the continuous PSFCH LBT failure detection, according to the third configuration information.

11. The method according to claim 10, wherein the first configuration information comprises any one of:
at least one of the continuous PSFCH LBT failure detection timer or a maximum value of the continuous PSFCH LBT failure detection corresponding to the resource pool;
at least one of a continuous PSFCH LBT failure detection timer or a maximum value of the continuous PSFCH LBT failure detection corresponding to a bandwidth part (BWP) to which the resource pool belongs; or
at least one of a continuous PSFCH LBT failure detection timer or a maximum value of the continuous PSFCH LBT failure detection corresponding to a cell to which the terminal device belongs.

12. (canceled)

13. The method according to claim 3, wherein counting the number of LBT failures for the PSFCH according to the number of LBT failures that continuously occur on the PSFCH associated with the HARQ-enabled PSSCH comprises:
starting or restarting a continuous PSFCH LBT failure detection timer corresponding to the BWP and incrementing a continuous PSFCH LBT failure detection counter corresponding to the BWP by 1, in a case where the LBT failure occurs on N continuous PSFCHs associated with any HARQ-enabled PSSCH; wherein N is a positive integer less than or equal to M, and M is a number of the PSFCHs associated with the HARQ-enabled PSSCH.

14. The method according to claim 13, further comprising:
determining that the BWP triggers a continuous PSFCH LBT failure, in a case where a number of LBT failures for the PSFCHs corresponding to the BWP is equal to or greater than a maximum value of a continuous PSFCH LBT failure detection; or
resetting the continuous PSFCH LBT failure detection counter corresponding to the BWP to be 0, in a case where the continuous PSFCH LBT failure detection timer corresponding to the BWP expires; or
resetting the continuous PSFCH LBT failure detection counter corresponding to the BWP to be 0, in a case where at least one of the continuous PSFCH LBT failure detection timer corresponding to the BWP or the maximum value of the continuous PSFCH LBT failure detection is reconfigured.

15. The method according to claim 14, further comprising:
sending continuous PSFCH LBT failure indication information to a network device, in response to determining that the BWP triggers the continuous PSFCH LBT failure; wherein the continuous PSFCH LBT failure indication information comprises indication information of the BWP; or
determining to trigger a sidelink radio link failure (RLF) in response to determining that the BWP triggers the continuous PSFCH LBT failure.

16.-19. (canceled)

20. The method according to claim 10, wherein the second configuration information comprises any one of:
at least one of the continuous PSFCH LBT failure detection timer or a maximum value of the continuous PSFCH LBT failure detection corresponding to the BWP; or at least one of a continuous PSFCH LBT failure detection timer or a maximum value of the continuous PSFCH LBT failure detection corresponding to a cell to which the terminal device belongs.

21. (canceled)

22. The method according to claim 321, wherein counting the number of LBT failures for the PSFCH according to the number of LBT failures that continuously occur on the PSFCH associated with the HARQ-enabled PSSCH comprises:
starting or restarting a continuous PSFCH LBT failure detection timer corresponding to the resource block set and incrementing a continuous PSFCH LBT failure detection counter corresponding to the resource block set by 1, in a case where the LBT failure occurs on N continuous PSFCHs associated with any HARQ-enabled PSSCH; wherein N is a positive integer less than or equal to M, and M is a number of the PSFCHs associated with the HARQ-enabled PSSCH.

23. The method according to claim 22, further comprising:
determining that the resource block set triggers a continuous PSFCH LBT failure, in a case where a number of LBT failures for the PSFCHs corresponding to the resource block set is equal to or greater than a maximum value of a continuous PSFCH LBT failure detection; or
resetting the continuous PSFCH LBT failure detection counter corresponding to the resource block set to be 0, in a case where the continuous PSFCH LBT failure detection timer corresponding to the resource block set expires; or
resetting the continuous PSFCH LBT failure detection counter corresponding to the resource block set to be 0, in a case where at least one of the continuous PSFCH LBT failure detection timer corresponding to the resource block set or the maximum value of the continuous PSFCH LBT failure detection is reconfigured.

24. The method according to claim 23, further comprising:
sending continuous PSFCH LBT failure indication information to a network device, in response to determining that the resource block set triggers the continuous PSFCH LBT failure; wherein the continuous PSFCH LBT failure indication information comprises indication information of the resource block set; or
triggering resource reselection to reselect a resource from a resource block set where the continuous PSFCH LBT failure has not occurred, in response to determining that the resource block set triggers the continuous PSFCH LBT failure and a resource allocation mode used by the terminal device is a mode of autonomously selecting from the resource block set.

25.-28. (canceled)

29. The method according to claim 10, wherein the third configuration information comprises any one of:
at least one of the continuous PSFCH LBT failure detection timer or a maximum value of the continuous PSFCH LBT failure detection corresponding to the resource block set;
at least one of a continuous PSFCH LBT failure detection timer or a maximum value of the continuous PSFCH LBT failure detection corresponding to a bandwidth part (BWP) to which the resource block set belongs; or
at least one of a continuous PSFCH LBT failure detection timer or a maximum value of the continuous PSFCH LBT failure detection corresponding to a cell to which the terminal device belongs.

30. (canceled)

31. A method for counting a number of consistent-listen before talk (LBT) failures, performed by a network device, comprising:
sending first configuration information to a terminal device, wherein the first configuration information is configured to determine, by the terminal device, a continuous physical sidelink feedback channel (PSFCH) LBT failure detection timer corresponding to a resource pool, and the continuous PSFCH LBT failure detection timer corresponding to the resource pool is configured to count a number of LBT failures for a PSFCH on the resource pool.

32. (canceled)

33. The method according to claim 31, further comprising:
sending second configuration information to the terminal device, wherein the second configuration information is configured to determine, by the terminal device, a continuous PSFCH LBT failure detection timer corresponding to a bandwidth part (BWP), and the continuous PSFCH LBT failure detection timer corresponding to the BWP is configured to count a number of LBT failures for a PSFCH on the BWP;
sending third configuration information to the terminal device, wherein the third configuration information is configured to determine, by the terminal device, a continuous PSFCH LBT failure detection timer corresponding to a resource block set, and the continuous PSFCH LBT failure detection timer corresponding to the resource block set is configured to count a number of LBT failures for a PSFCH on the resource block set; or
sending fourth configuration information to the terminal device, wherein the fourth configuration information is configured to determine a value of N by terminal device; and
N is a number of PSFCHs, determined by the terminal device, on which the LBT failure continuously occur and which are associated with a hybrid automatic repeat request (HARQ)-enabled PSSCH.

34.-39. (canceled)

40. A communication device, comprising:
one or more processors; and
a memory that stores a computer program, wherein
the computer program, when collectively executed by the one or more processors, causes the communication device to:
determine a number of LBT failures that continuously occur on a physical sidelink feedback channel (PSFCH) associated with a hybrid automatic repeat request (HARQ)-enabled physical sidelink shared channel (PSSCH); and
count a number of LBT failures for the PSFCH according to the number of LBT failures that continuously occur on the PSFCH associated with the HARQ-enabled PSSCH.

41. (canceled)

42. A communication device, comprising:
one or more processors; and
a memory that stores a computer program, wherein
the computer program, when collectively executed by the one or more processors, causes the communication device to act as the network device and perform the method according to claim 31.
